(19) United States
(12) Patent Application Publication
(10) Pub. No.: US 2014/0087250 A1
(43) Pub. Date: Mar. 27, 2014

(54) BINDER FOR A SECONDARY BATTERY CELL

(71) Applicants: Fazlil Coowar, Shirley (GB); Mamdouh Elsayed Abdelsalam, St Denys (GB)

(72) Inventors: Fazlil Coowar, Shirley (GB); Mamdouh Elsayed Abdelsalam, St Denys (GB)

(73) Assignee: Nexeon Ltd, Abingdon (GB)

(21) Appl. No.: 13/982,394

(22) PCT Filed: Jan. 27, 2012
(86) PCT No.: PCT/GB2012/050174

§ 371 Date: Dec. 12, 2013

(30) Foreign Application Priority Data
Jan. 27, 2011 (GB) 1101427.1

(51) Int. Cl. H01M 4/62; H01M 4/04

(52) U.S. Cl. CPC H01M 4/622; H01M 4/04; H01M 4/625
USPC 429/211; 429/217; 29/623.1; 252/182.1; 252/511

(57) ABSTRACT

A binder composition for inclusion in a composite material used in the formation of an electrode for inclusion in a secondary battery is provided. The binder composition comprises a metai ion sait of a carboxyiic acid of a poiymer or a copolymer, wherein the polymer or copolymer includes as a substituent one or more carboxyl comprising groups derived from a carboxyl comprising monomer unit selected from the group consisting an acrylic acid, an acrylic acid derivative, a maleic acid, a maleic acid derivative, a maleic anhydride and a maleic anhydride derivative, characterised in that 80 to 20% of the carboxyl groups are derived from an acrylic acid, an acrylic acid derivative, a maleic acid or a maleic acid derivative and 20 to 80% of the carboxyl groups are derived from maleic anhydride or a maleic anhydride derivative, but excluding lithium polyethylene-alt-maleic anhydride and lithium and sodium poly(maleic acid-co- acrylic acid). Composite electrode materials, electrode mixes, electrodes and electrochemical cells including the binder are provided.

The present invention relates to a binder for an electrode material; to a composite electrode material comprising the binder; to an electrode comprising the composite electrode material, especially a negative electrode; to cells including electrodes or anodes including the binder and/or composite electrode material; and to devices including said cells.

Secondary batteries, such as lithium ion rechargeable batteries comprise a family of batteries in which one or more charge carriers such as lithium, sodium, potassium, calcium or magnesium ions move from the negative electrode to the positive electrode during discharge and back again during the charging phase. Such secondary batteries are common in consumer electronics because they generally exhibit a good energy to weight ratio, a negligible memory effect and a slow loss of charge when not in use. The high energy density characteristics of these batteries mean that they can also be used in aerospace, military and vehicle applications. Another family of secondary batteries are metal-air batteries, such as silicon-air batteries, which use the reduction of oxygen at the cathode and oxidation at the anode to produce current flow.

A secondary battery such as a lithium ion rechargeable cell, typically comprises a negative electrode (herein referred to as the anode), a positive electrode (herein referred to as the cathode) and an electrolyte. The anode conventionally comprises a copper current collector having a graphite based composite layer applied thereto. The cathode is generally formed from a material comprising a charge carrier species or comprises a current collector having a composite layer including a charge carrier species applied thereto. Examples of commonly used charge carriers include alkali metal ions such as ions of lithium, sodium and potassium and alkali earth metal ions such as calcium and magnesium. For lithium ion rechargeable batteries, the cathode conventionally comprises an aluminium current collector having a lithium comprising metal oxide based composite layer applied thereto. A porous plastic spacer or separator is provided between the anode and the cathode and a liquid electrolyte is dispersed between the porous plastic spacer, the composite anode layer and the composite cathode layer.

The battery can be charged by applying a charging voltage across the current collectors of the anode and the cathode. During charging of a lithium-ion battery, lithium ions migrate from the lithium comprising composite metal oxide layer of the cathode to the anode where they become embedded in the graphite in a process known as insertion to form a lithium carbon insertion compound, for example LiC₆. During the discharge process, the lithium ions are extracted or removed from the graphite and travel back through the electrolyte to the cathode. Similarly, charge and discharge of a sodium or magnesium based battery requires the reversible transfer of sodium or magnesium ions respectively from one electrode to another.

Work is obtained from the battery on discharge by placing it across a closed external circuit. The amount of useful work obtained depends on both the magnitude of the charging voltage applied as well as the gravimetric capacity of the anode and cathode active materials. A lithium intercalated graphite material, for example, has a maximum theoretical gravimetric capacity of 372 mAh/g. Although the gravimetric capacity provided by graphite based electrodes is sufficient for many applications, the development of new applications having greater power requirements has necessitated the development of lithium ion rechargeable batteries including electrode materials having a greater gravimetric capacity than graphite. This, in turn, has led to the development of electrodes such as anodes in which a silicon, germanium, tin or gallium-based composite layer is applied to the current collector. Like graphite, silicon also forms insertion compounds with lithium during the charging phase of the battery. The lithium-silicon insertion compound, Li₂₁Si₅ has a maximum theoretical gravimetric capacity of 4,200 mAh/g. Germanium also forms a lithium insertion compound, Li₂₁Ge₅; this has a maximum theoretical capacity of 1624 mAh/g. Tin forms an insertion compound, Li₂₁Sn₅, which has a maximum theoretical gravimetric capacity of between 800 and 1000 mAh/g. Lithium insertion compounds of gallium are also known with a maximum theoretical gravimetric capacity of 577 mAh/g. Batteries comprising silicon, germanium, gallium and tin based anodes potentially have significantly higher inherent capacities than those comprising graphite based anodes; these higher energy densities mean such batteries are potentially suitable for use in devices having substantial power requirements. Unfortunately, the process of lithium insertion and extraction or removal (into and from the silicon, germanium, gallium and tin anode material during the charging and discharging phases respectively) is associated with a huge volume change (e.g. up to 300% increase in volume during charging for silicon compounds), which is much larger than the corresponding volume changes observed for cells containing graphite anodes. These significant volume changes result in the build up of a significant amount of stress within the electrode structure, which causes the electrode material to crack and leads to both a loss of cohesion within the composite material and a loss of adhesion of the composite electrode material from the current collector.

For most secondary battery applications, the composite layer (silicon or graphite) applied to the electrode current collector typically comprises an electroactive material such as silicon, tin, germanium, gallium or graphite and a binder. A binder is used to provide good cohesion between the components of the composite electrode material, good adhesion of the electroactive material to the current collector and to promote good electrical conductivity between the electroactive material and the current collector.

By the term “composite electrode material” it should be understood to mean a material comprising a mixture, preferably a substantially homogeneous mixture, of an electroactive material, a binder and optionally one or more further ingredients selected from the group comprising a conductive material, a viscosity adjuster, a filler, a cross-linking accelerator, a coupling agent and an adhesive accelerator. The components of the composite material are suitably mixed together to form a homogeneous composite electrode material that can be applied as a coating to a substrate or current collector to form a composite electrode layer. Preferably the components of the composite electrode material are mixed with a solvent to form an electrode mix, which electrode mix can then be applied to a substrate or current collector and dried to form the composite electrode material.

By the term “electrode mix” it should be understood to mean compositions including a slurry or dispersion of an electroactive material in a solution of a binder as a carrier or solvent. It should also be understood to mean a slurry or dispersion of an electroactive material and a binder in a solvent or liquid carrier.

By the term “electroactive material” it should be understood to mean a material, which is able to incorporate into its structure and substantially release there from, metal ion charge carriers such as lithium, sodium, potassium, calcium or magnesium during the charging phase and discharging phase of a battery. Preferably the material is able to incorporate (or insert) and release lithium.

According to EP 2 058 882 a binder for a rechargeable lithium ion battery must exhibit the following properties:
It must provide good corrosion resistance by providing the current collector with a protective layer to prevent damage by the electrolyte;
It must be able to hold the components of the composite electrode material together as a cohesive mass;
It must provide strong adhesion between the composite layer and the current collector.
It must be stable under battery conditions; and
It must be conductive or have a low internal resistance.

The binders typically used in the manufacture of graphite composite electrodes include thermoplastic polymers such as polyvinylidene fluoride (PVdF), polyvinylalcohol (PVA) or styrene butadiene rubber (SBR). However, use of such binders in silicon systems has not resulted in electrodes having sufficient strength or charge characteristics to allow use on a commercial scale. For example, according to KR 2008038806A, a PVA binder in a silicon based anode system is unable to produce a uniform coating on a copper current collector. In addition it has been observed (KR 2008038806A) that the electrically insulating polymer binders PVDF and SBR are unable to retain either cohesion within the body of the composite electrode material or adhesion of this material to the anode current collector during the charging and discharging phases of the battery. This loss of cohesion and/or adhesion results in an increase in the internal resistance of the electrode and leads to a rapid deterioration in the electrical performance of batteries including composite electrode materials containing these binders. In order to overcome these problems, KR 2008038806A teaches ultra-violet and ozone treatment of the conductive component and binder of the composite material disclosed therein prior to fabrication.

The first cycle irreversible capacity loss for cells comprising a silicon-comprising composite anode material and one or more binders selected from the group comprising PVDF, aromatic and aliphatic polyimides and polyacrylates has been found to be unacceptably large (WO 2008/097723). This may be due to the tendency of these binders to swell in the electrolyte solutions used in batteries.

It will be appreciated from the foregoing that a major problem associated with the use of binders traditionally used in graphite based systems (such as PVdF, PVA and SBR) in silicon based systems is the build up of electrical resistance within the electrode structure due to decomposition of the composite electrode material itself (loss of cohesion) and loss of adhesion between the composite material and the current collector. Attempts to solve this problem have included approaches such as improving the electrical conductivity of the binder and modifying the binder in order to achieve improved cohesiveness within the composite material itself and improved adhesion between the composite material and the current collector.

An example of the first approach to this problem (improving the conductivity of the binder) is presented in US 2007/0202402, which discloses polymer binders including carbon nano-tubes. Examples of suggested polymer binders to which the carbon nano-tubes can be added to enhance the binder conductivity include polyester acrylates, epoxy acrylates, urethane acrylates, polyurethanes, fluoropolymers such as PVdF, PVA, polyimides, polyacrylic acids and styrene butadiene rubbers. Of these suggested binders, only PVDF and PVA are exemplified.

The second approach (binder modification) involves selecting as the binder a polymer or polymer mixture in which the or at least one polymer in the polymer mixture includes within its structure a functional group that is able to bond to the surface of the electroactive material of the composite and/or the surface of the current collector. This approach is outlined in more detail by Sugama et al in J. Materials Science 19 (1984) 4045-4056, by Chen et al, J. Applied Electrochem. (2006) 36:1099-1104 and by Hochgatterer et al, Electrochem. & Solid State Letters, 11(5) A76-A80 (2008).

Sugama et al (J. Materials Science 19 (1984) 4045-4056) investigated the interaction between iron (III) orthophosphate or zinc phosphate hydrate films and polyacrylic acid macromolecules in which between 0 and 80% of the carboxyl (COOH) groups in the macromolecule had been neutralised with sodium hydroxide. The study was based on the assumption that macromolecules containing a carboxyl group (COOH) would be able to form strong bonds with the metal (iron or zinc) surface as a result of a condensation reaction between the carboxyl group of the macromolecule and the hydroxyl (OH) groups found on the surface of the metal film. The adhesive strength and wetting characteristics of the macromolecules was found to depend upon the degree of neutralisation of the polyacrylic acid macromolecule. Polyacrylic acid macromolecules in which either 0 or 80% of the carboxyl groups had been neutralised exhibited poor wetting or adhesion characteristics. It was suggested that the extensive hydrogen bonding present in the un-neutralised polyacrylic acid macromolecules reduced the number of active groups available to bind to the hydroxyl groups on the metal surface. Conversely, it was suggested that for the polyacrylic acid system in which 80% of the carboxyl groups had been neutralised, the reduction in available inter-molecular hydrogen bonding resulted in increased inter-molecular entanglement, which also limited the availability of active groups for bonding to the metal surface. The best results were obtained using a polyacrylic acid having an intermediate level of neutralisation. It was observed that since polyacrylic acid macromolecules have a tendency to swell in water optimum adhesive properties could be achieved by ensuring that the polyacrylic acid macromolecules contained only sufficient carboxyl groups to react with the hydroxyl groups on the surface of the metal film; an excess of carboxyl groups was believed to lead to the swelling of polyacrylic acid macromolecules on the metal surface in aqueous systems.

Chen et al (J. Applied Electrochem. (2006) 36:1099-1104) investigated the effect of PVDF, an acrylic adhesive binder and a modified acrylic adhesive binder on the cycling performance of silicon/carbon composite electrodes containing nano-sized silicon powder in lithium ion batteries. The acrylic adhesive, referred to as LA132, is believed to be a mixture of acrylonitrile and butadiene in methylethyl ketone, ethyl acetate and toluene. The modified acrylic adhesive binder was a mixture of LA132 and sodium carboxymethyl cellulose (Na-CMC). Electrodes formed using the acrylic adhesives were found to exhibit better adhesion and cycling performance compared to the PVDF binder. The best performance was obtained from electrodes including the modified acrylic binder. It was observed that PVDF binders had a greater tendency to swell in electrolyte solutions compared to acrylic adhesive binders.

Hochgatterer et al, Electrochem. & Solid State Letters, 11(5) A76-A80 (2008) investigated the effect of Na-CMC, hydroxyethyl cellulose, cyanocellulose and PVDF based binders on the cycling stability of silicon/graphite based composite anodes using a lithium cathode. The authors observed that improved cycling performance was obtained by replacing the flexible PVDF based binder with a more brittle Na-CMC based binder and suggested that this improved performance was due to bond formation between the Na-CMC and the silicon surface (similar to the scheme outlined by Sugama et al), which bond formation helps to retain the shape of the silicon particles during the charge and discharge cycles. It was suggested that the establishment of a chemical bond between the electroactive material and the binder was a more important factor for battery life than binder flexibility.

The preparation of silicon based anodes using CMC and Na-CMC binders is further disclosed in Electrochemical and Solid State Letters, 10 (2) A17-A20 (2007) and Electrochemical and Solid State Letters, 8 (2) A100-A103 (2005). These papers also demonstrate that the use of Na-CMC results in an improved cycle life over the ‘standard’ PVdF binder when using micron scale powdered Si anode materials or Si/C composite anode material. However, these binders are only able to provide effective adhesion for electroactive materials having a silicon purity of greater than 99.95%. The divalent and trivalent metal ion impurities in silicon materials having a purity of less than 99.95% cause degradation of the CMC binders in battery environments and loss of performance. Binder systems comprising a chelating agent and CMC or Na-CMC can be used for silicon based anodes in which the silicon purity is less than 99.90% (WO 2010/130975). However, the inclusion of a chelating agent increases the complexity of the binder system and may affect the amount of lithium available for inclusion into and release from the silicon structure during the charging and discharging cycles of the battery.

WO 2010/130976 discloses silicon based electrodes containing a polyacrylic acid (PAA) binder. Cells produced using these PAA binders and sodium salts of these PAA binders (Na-PAA) exhibited a capacity retention of the order of 98% over between 150 and 200 cell cycles. The binders of WO 2010/130976 can be used in the preparation of anodes containing highly pure silicon powder, metallurgical grade silicon powder, silicon fibres and pillared particles of silicon as the electroactive material.

WO 2008/097723 discloses anodes for lithium ion electrochemical cells. The anodes comprise a silicon based alloy as the electroactive material and a non-elastic lithium polysalt binder. Examples of lithium polymer salts that can be used as binders include lithium polyacrylate, lithium poly(ethylene-alt-maleic acid), lithium polystyrenesulfonate, lithium polysulfonate fluoropolymer, polyacrylonitrile, cured phenolic resin, cured glucose, a lithium salt of a copolymer that includes maleic acid or sulfonic acid or mixtures thereof; the inventors believe that these lithium polysalts are able to coat a powdered active material to form an ionically conductive layer. Composite anodes including either a silicon-iron-titanium alloy or graphite as an active material and a binder selected from the group comprising lithium polyethylene-alt-maleic acid, lithium polyacrylic acid, lithium poly(methylvinylether-alt-maleic acid) and lithium polysulfonate fluoropolymer were prepared. For both active materials referred to above, the capacity loss associated with cells including these composite materials was inversely proportional to the amount of binder in the composite. There was very little difference in the performance of the cells over 50 cycles (graphite vs silicon alloy) for a fixed amount of binder. Cells including lithium polysalt binders exhibited comparable or marginally superior performance per cycle compared to cells including binders such as PVDF, polyimide or Na-CMC; lithium polysulfonate binders exhibited marginally better performance compared to the other binders disclosed in WO 2008/097723.

US 2007/0065720 discloses a negative electrode for a lithium ion secondary battery, which includes a binder having an average molecular weight in the range 50,000 to 1,500,000 and an electroactive material that is capable of absorbing and desorbing lithium. The electroactive material can be selected from silicon or tin and alloys and oxides of silicon or tin. Alloys of silicon with titanium are preferred. The binder comprises at least one polymer selected from the group comprising PAA and polymethacrylic acid, with the proviso that 20 to 80% of the carboxyl groups in the polymer structure have been condensed to produce acid anhydride groups, which reduces the tendency of the binder to absorb water and therefore the consequential breakdown of the electrode material. Partial replacement of the carboxyl groups within the binder structure means that the binder is still able to effectively adhere to the surface of the electroactive material.

US 2007/0026313 discloses a moulded negative electrode for a lithium ion battery, which includes a silicon comprising electroactive material and a non-cross linked PAA binder having an average molecular weight of 300,000 to 3,000,000. Cross-linked PAA, their alkali metal salts and alkali metal salts of non-cross linked PAA are excluded from US 2007/0026313 because they are hygroscopic and tend to absorb water, which reacts with the silicon in the electroactive material to release a gas. The evolution of gas tends to impede the performance of the electrode. It was suggested that the use of non-cross linked PAA having an average molecular weight of 300,000 to 3,000,000 provides a balance between electrode strength and dispersion of the electroactive material within the electrode structure.

Electrodes comprising a composite layer of silicon fibres on a copper current collector have also been prepared (WO 2007/083155). Silicon fibres having a diameter in the range 0.08 to 0.5 microns, a length in the range 20 to 300 microns and an aspect ratio (diameter:length) in the range 1:100 were mixed with a conductive carbon and were subsequently formed into a composite felt or mat using a PVDF binder.

It will be appreciated from the foregoing that one problem associated with binders containing a carboxyl (COOH) group is that they are not always stable in the cell electrolytes and may undergo reactions with the electrolyte and other cell components during the cell cycling, which leads to a breakdown of the cell structure. In addition non-elastic binders such as PAA are not always able to accommodate the volume changes that take place within anodes including an electroactive material such as silicon, germanium, tin or gallium during the charging and discharging phases of the battery. This can lead to a breakdown of cohesiveness within the electrode structure and loss of lamination from the current collector.

There has also been a considerable amount of research into binder mixtures. WO 2010/060348 discloses a polymer mixture that can be used as a binder for a silicon-based lithium ion electrode. The binder is formed from a three component mixture comprising, as a first component, polymers that improve the elasticity of the film; a second component comprising polymers that increase the interactions between the components of the electroactive material; as a third component comprising polymers that are able improve the binding force of the silicon negative electrode to the current collector. Examples of polymers that are believed increase the elasticity of the film and may avoid flaking of the negative electrode material include those formed by polymerisation of a fluorine-containing monomer. Copolymers of the fluorine-containing monomer with a functional group-containing monomer are preferred. Examples of fluorine-containing monomers include vinylidene fluoride, fluoroethylene, trifluoroethylene, tetrafluoroethylene, pentafluoroethylene and hexafluoroethylene. Examples of monomers containing a functional group include monomers containing a functional group such as a halogen, oxygen, nitrogen, phosphorus, sulphur, a carboxyl group or a carbonyl group. Compounds such as acrylic acid, methacrylic acid, maleic acid, unsaturated aldehydes and unsaturated ketones provide examples of monomers containing a carboxyl or carbonyl functional group. Polymers having a number average molecular weight of between 1×10⁵ and 1×10⁶ are preferred. Where the polymer contains a functional group the weight ratio of the functional group containing monomer and the fluorine-containing monomer is in the range 1:10 to 1:1000.

Examples of polymers that are believed to increase the interaction between the components of the electroactive material in WO 2010/060348 include polymers formed by polymerisation of a monomer such as acrylonitrile, methacrylonitrile, an acrylate, a methacrylate or mixtures thereof. Polymers having a number average molecular weight of between 1×10³ and 1×10⁶ are preferred.

Examples of polymers that are believed to improve the binding force of the silicon negative electrode in WO 2010/060348 include polyvinylpyrrolidone (PVP), polyglycol (PEG), poly(alkylidene)glycol, polyacrylamide and mixtures thereof. Polymers having a number average molecular weight of between 500 and 1×10⁷ are preferred.

KR 845702 also discloses a binder comprising a polymer formed by copolymerisation of at least one monomer selected from the group comprising a (meth)acrylic acid ester-based monomer, a vinyl based monomer, a conjugated diene based monomer and a nitrile group-containing compound with at least one compound selected from the group comprising an acrylate based monomer including a group selected from alkyl, alkenyl, aryl, C₂₋₂₀ pentaerythritol, ethylene glycol, propylene glycol and a C₂₋₂₀ urethane. The copolymer binders include both a hydrophilic group, which is believed to enhance the adhesion of the binder to the current collector and the components of the composite; and a hydrophobic group, which promotes dispersion of the active particles within the electrode mass. The copolymer binders of KR 845702 are believed to have excellent adhesive strength and coating properties.

JP 2004095264 discloses a silicon composite anode for a lithium ion battery, the anode comprising a current collector, a composite layer including an acrylate-containing binder and a separate adhesive layer provided between the binder containing composite layer and the current collector. The adhesive layer comprises an acrylate-substituted high molecular weight fluorine-containing polymer. The high molecular weight fluorine-containing polymer coats the current collector and provides a protective film to prevent corrosion of the current collector. Strong adhesion between the high molecular weight fluorine-containing polymer and the acrylate-containing binder is also observed.

A moulded silicon-comprising composite electrode comprising a polyimide and a PAA mix is disclosed in WO 2010/130976.

U.S. Pat. No. 5,525,444 and JP7226205 disclose a binder for an alkaline secondary battery, the binder comprising a copolymer consisting of a vinyl alcohol unit and a unit having a COOX group, wherein X is an element selected from the group comprising hydrogen, alkaline metals and alkaline earth metals. The binders are used to prepare electrodes comprising lanthanum based electroactive materials. The combination of the hydrophilic COOX group and the more hydrophobic vinyl group means that the binder promotes good adhesion between the electroactive material and the current collector and good dispersion of the electroactive material within the electrode composition.

Anode compositions for lithium batteries are also disclosed in EP 1 489 673. These anode compositions include an anode active material, a synthetic rubber binder, a cellulose-based dispersing agent and a water-soluble anionic polyelectrolyte selected from the group comprising citric acid, tartaric acid, succinic acid, poly(meth)acrylic acid, polymethacrylates and the sodium and ammonium salts thereof. The combination of the synthetic rubber binder, the cellulose and the polyelectrolyte is believed to reduce delamination of the anode active material and therefore short circuiting. It is also believed to improve dispersion of the anode active material within the electrode mix, which, according to EP 1 489 673 leads to batteries having a high energy density and improved safety.

U.S. Pat. No. 6,617,374 discloses a dental adhesive comprising a mixed salt of a copolymer of alkyl vinyl ether and either maleic acid or maleic anhydride. Terpolymers with isobutylene are also envisaged. The mixed salt comprises a cationic salt function of 22.5% calcium ions, about 15 to 25% zinc ions and 3 to 50% free acid. Only binder compositions comprising free acid salts are exemplified.

DE 4426564 discloses a cement composition comprising a metal ion salt of a copolymer of maleic acid and iso-butene. The copolymers preferably have a molecular weight in the range 1000 to 20,000 and 50 to 100% of the carboxyl groups are provided in the form of an alkali metal salt, preferably a sodium salt. There is no indication that the cement compositions can be used in battery applications.

The binder mixtures referred to above can be costly and complex to prepare. Care is required to ensure that the components of the mixture are combined in the correct proportions. Minor variations in the number average molecular weight may have detrimental effects on the binding capability. Also, impurities in the components of the composite electrode material may adversely affect the binding capability of the binder mixture.

There is a need, therefore, for a binder that is able to adhere to both the components of the composite electrode material and to the current collector. There is also a need for a binder that is able to at least partially accommodate the volume changes undergone by the electroactive silicon material during the charging and discharging phases of the battery. There is also a need for a binder that does not undergo excessive swelling in an electrolyte solution. There is also a need for a binder system comprising a minimum number of components. There is also a need for a binder that does not significantly impede the insertion of the charge transport ion (e.g. lithium ion) into the electroactive material. There is a further need for a binder that is able to bind a silicon-comprising composite material including a highly pure silicon material as well as a silicon-comprising composite material including a silicon material having a silicon purity in the range 90.00% to 99.99%, preferably 95 to 99.95% and especially 98.00% to 99.95%.

There is a still further need for a binder, which helps to promote the formation of a more stable and less resistive solid electrolyte interphase (SEI) layer during the initial charge/discharge cycles. The present invention addresses those needs.

A first aspect of the invention provides a binder composition comprising a metal ion salt of a carboxylic acid of a polymer or a copolymer, wherein the polymer or copolymer includes as a substituent, one or more carboxyl comprising groups, each carboxyl comprising group being derived from a carboxyl comprising monomer unit selected from the group consisting an acrylic acid, an acrylic acid derivative, a maleic acid, a maleic acid derivative, a maleic anhydride and a maleic anhydride derivative, characterised in that 80 to 20% of the carboxyl groups are derived from an acrylic acid, an acrylic acid derivative, a maleic acid or a maleic acid derivative and 20 to 80% of the carboxyl groups are derived from maleic anhydride or a maleic anhydride derivative but excluding lithium salts of poly(ethylene-alt-maleic acid). Preferably the carboxyl comprising group is derived from an ethylene maleic acid monomer unit or an ethylene maleic anhydride monomer unit.

By the term acrylic acid, it should be understood to mean an organic acid having an sag unsaturation between a carboxyl oxygen and a carbon-carbon double bond within its structure. Therefore, in the context of the present invention, the term “acrylic acid” includes acrylic acid; 3-butenoic acid; 2-methacrylic acid; 2-pentenoic acid; 2,3-dimethylacrylic acid; 3,3-dimethylacrylic acid; trans-butenedioic acid; cis-butenedioic acid and itaconic acid. The term “acrylic acid derivatives” should be understood to mean esters, anhydrides and amides of any of the acrylic acid structures referred to above as well as metal ion salts of the acids. The term “derivative” also includes structures in which one or more hydrogen atoms in the acrylic acid structure has been replaced (substituted) by an alkyl, an alkenyl or an alkynyl group.

By the term maleic acid derivative it should be understood to mean esters and amides of any of the maleic acid structures referred to above as well as metal ion salts of the acids. The term “derivative” also includes structures in which one or more hydrogen atoms in the maleic acid structure has been replaced (substituted) by an alkyl, an alkenyl or an alkynyl group.

By the term maleic anhydride derivative it should be understood to include structures in which one or more hydrogen atoms in the maleic anhydride structure has been replaced (substituted) by an alkyl, an alkenyl or an alkynyl group. Examples of maleic anhydride derivatives include but are not limited to ethyl maleic anhydride, ethylene maleic anhydride, propylene maleic anhydride and butylene maleic anhydride.

By the term “carboxyl substituent” it should be understood to mean a structure in which a hydrogen atom attached to a carbon atom within the polymer structure has been replaced by a carboxyl group. This may be a hydrogen atom attached to the backbone of the polymer or it may be a hydrogen atom attached to a pendant carbon atom. Preferably the carboxyl substituents are attached to the backbone of the polymer.

The binders of the present invention suitably include, in one embodiment, a copolymer comprising 20 to 80% of a maleic anhydride or maleic anhydride derivative and 80 to 20% of carboxylic acid monomer unit selected from an acrylic acid, an acrylic acid derivative, a maleic acid, a maleic acid derivative or a mixture thereof. The binders include as an essential feature one or more maleic anhydride units or derivatives thereof. In a preferred embodiment of the first aspect of the invention the binders include within their structure one or more maleic acid metal ion salt units and one or more maleic anhydride units. In a more preferred embodiment of the first aspect of the invention, the binders include within their structure one or more ethyl maleic acid metal ion salt units and one or more ethyl maleic anhydride units. An especially preferred binder composition of the first aspect of the invention comprises 20 to 80% by weight of ethylene maleic anhydride and 80 to 20% by weight of a sodium salt of ethylene maleic acid.

By the term “unit” or “monomer unit” it should be understood to mean the radical structure, which is derived from the basic structure of the corresponding monomer, that is to say the basic arrangements of atoms within the monomer unit. The radical contains one or more free electrons derived from the carbon-carbon double bond of the monomer from which the unit is derived, the electrons being consumed during the formation of the polymer or copolymer.

Suitable metal ion salts of the polymers or copolymers of the present invention include salts of lithium, sodium, potassium, calcium, magnesium, caesium and zinc. Sodium salts are preferred. The binder compositions of the first aspect of the invention are typically mixed with an electroactive material to form a composite electrode material. Composite electrode materials can be prepared by forming a solution of the binder composition in a suitable solvent and mixing the binder solution with the electroactive material to form an electrode mix as defined above. The resulting electrode mix can be coated onto a substrate (such as a current collector) to a predefined coating thickness and dried to remove the solvent to give a layer of a composite electrode material on the substrate or current collector. The composite electrode material including the binder of the first aspect of the invention is a cohesive material in which the short term order of the components of the material is substantially retained by the binder according to the first aspect of the invention over at least 100 charging and discharging cycles of a battery including a composite material comprising the binder according to the first aspect of the invention. Examples of suitable solvents that can be used to form an electrode mix include water, N-methyl-pyrrolidone (NMP), an alcohol such as ethanol, propanol, butanol or a mixture thereof.

The composite electrode materials prepared using the binders of the present invention can be used to prepare electrodes, preferably anodes suitable for use in the manufacture of secondary batteries such as lithium ion rechargeable batteries. It has been found that batteries including anodes prepared using the binder compositions of the present invention exhibit good capacity retention over at least 100 cycles, for example over 120 cycles. It has been found that when the composite materials including the binder of the present invention are included in a battery, they exhibit a discharge capacity of in excess of 500 mAh/g, preferably in excess of 800 mAh/g and typically in the range of 1,000-3,000 mAh/g (where the capacity is calculated per gram of electroactive material in the composite).

The metal ion salt of the carboxylic acid of the polymer or copolymer of the first aspect of the invention may be a metal ion salt of a homopolymer or of an alternating, periodic, block or graft copolymer. The number of carboxyl groups present in the polymer or copolymer carboxylic acid salts of the present invention will suitably be in the range 20 to 200% of the total number of monomers units present in the polymer or copolymer, preferably 30 to 200%, more preferably 40 to 200% and especially 60 to 200% and particularly 70 to 200%. As specified above, the binder composition of the first aspect of the invention preferably comprises a metal ion salt of a copolymer comprising 20 to 80% of ethylene maleic anhydride and 80 to 20% of ethylene maleic acid, particularly the sodium salt thereof but excluding the lithium salt of polyethylene-alt-maleic acid. The polymer binder according to the first aspect of the invention may also be provided as a terpolymer, which comprises in addition to the maleic anhydride unit and the carboxylic acid unit a further monomer species. Preferably the further monomer unit comprises a hydrophobic monomer, since units of this type tend to promote adhesion within an electrode mix and between an electrode mix and an underlying current collector. The polymer or copolymer may be used alone or together with one or more alternative metal ion salts of a binder according to the first aspect of the invention or together with one or more other known binders such as PVDF, styrene butadiene rubber, CMC, Na-CMC and the like.

As indicated above, the polymer or copolymer binders of the present invention are provided in the form of a carboxylic acid metal ion salt. The polymer or copolymer salts according to the first aspect of the invention may be prepared by reacting a starting polymer or copolymer, which includes as a substituent one or more carboxyl groups derived from maleic anhydride and optionally from maleic acid, a maleic acid derivative, an acrylic acid or an acrylic acid derivative with a metal ion base, for example a base such as a hydroxide or a carbonate of a suitable metal ion. Preferred starting polymers or copolymers comprise 20 to 100% of maleic anhydride monomer units and 0 to 80% of carboxylic acid monomer units selected from the group comprising maleic acid, a maleic acid derivative, acrylic acid or an acrylic acid derivative. It is especially preferred that the maleic anhydride monomer unit is an ethylene maleic anhydride monomer unit and the maleic acid monomer unit is an ethylene maleic acid monomer unit. Preferred bases include hydroxides and carbonates of sodium. The anion of the base suitably reacts with either or both of the anhydride group and/or the acid group within the polymer to give the corresponding carboxyl group. The metal ions react with the carboxyl groups generated in the polymer or copolymer structure to give the salt of the corresponding maleic acid.

Bases including anions such as hydroxyl and carbonate groups are preferred since their use leaves little or no residue in the composite electrode material structure. A metal hydroxyl will react with an anhydride group or a carboxylic acid group or both to form water on formation of a metal ion carboxylic acid salt, which is evaporated when the electrode is dried. A metal ion carbonate reacts with both an anhydride group and a carboxylic acid group to form carbon dioxide gas on formation of a metal ion carboxylic acid salt, which gas is evolved from the mixture. The use of carbonates may introduce porosity into the structure of the electrode material, which may be beneficial.

Where the starting polymer comprises maleic anhydride units and optionally maleic acid units, the number of maleic acid metal ion salt units formed within the structure of the resulting polymer binder depends on both the total number of maleic anhydride and optionally maleic acid groups in the starting polymer or copolymer and the concentration and amount of the metal ion comprising base that reacts therewith. Since both a maleic anhydride group and a maleic acid group (where present) are capable of reacting with two equivalents of a base comprising a monovalent metal ion (such as a hydroxide or carbonate of sodium or potassium) or one equivalent of a base of a base comprising a divalent metal ion (such as calcium or magnesium), it will be appreciated that it is possible to control the total number of carboxyl groups that are converted to the corresponding acid salt within the polymer or copolymer structure by controlling amount and the concentration of a solution comprising a base of a mono-valent or di-valent metal ion that reacts with the polymer. In a preferred embodiment, it is possible to control the number of maleic anhydride groups that are converted to a maleic acid salt using polyethylene-alt-maleic anhydride as a starting material by controlling the amount and concentration of the base of the metal ion that reacts therewith.

Similar considerations will apply to the formation of carboxylic acid metal ion salts of copolymers from starting materials comprising copolymers of maleic anhydride and maleic acid or acrylic acid or mixtures thereof. Monomer units including maleic anhydride or maleic acid require two equivalents of a monovalent metal ion or one equivalent of a divalent metal ion for complete conversion of all the carboxyl groups to carboxylic metal ion salts. Monomer units including acrylic acid only require one equivalent of a monovalent metal ion of half equivalent of a divalent metal ion. It will therefore be appreciated by a skilled person that where a polymer or copolymer contains a mixture of carboxylic acid groups derived from maleic acid or acrylic acid and anhydride groups, it is also possible to control the degree of salt formation in a similar way. As with polymers comprising anhydride groups only, the total concentration of carboxyl groups within the polymer can be determined and the amount and concentration of base required for formation of a polymer salt having a predetermined degree of salt formation can be determined.

The number of carboxyl groups (acid, ester or anhydride) within a polymer or copolymer that are converted to the corresponding carboxylic acid metal salt can be expressed in terms of the total number of carboxyl groups present in the polymer and is commonly referred to as the degree of neutralisation or degree of salt formation. Where the binder is formed by reacting a metal ion salt with a starting polymer comprising maleic anhydride comprising monomer units, for example ethylene maleic anhydride monomer units, the number of maleic anhydride units that are converted to the corresponding maleic acid units can be expressed in terms of the total number of carboxyl groups initially present in the starting polymer and it is the ratio of the number of carboxyl groups converted to the total number of carboxyl groups that is defined as the degree of neutralisation or degree of salt formation.

Preferably the metal ion polymer or copolymer salts of the first aspect of the present invention have a degree of salt formation in the range 30 to 80%, suitably 40 to 80%, preferably 45% to 75%, more preferably 50% to 70%, especially 50 to 60% and particularly 50%. Sodium salts of the polymer or copolymer are preferred. The use of a sodium salt of polyethylene-alt-(maleic acid-maleicanhydride) comprising at least 20% maleic anhydride is especially preferred. It should be appreciated that the metal ion salts of the maleic acid-maleic anhydride comprising copolymers of the present invention have a greater solubility in solvents such as water than the polymers and copolymers from which they are derived. These maleic acid-maleic anhydride comprising polymer salts are preferably obtained by reacting polyethylene-alt-maleic anhydride with a base of a monovalent metal ion.

Full cells including anodes prepared using a silicon comprising active material and polymeric binders of the first aspect of the invention and having a degree of salt formation of 75% are able to retain a capacity of 1200 mAh/g over approximately 145 cycles. Full cells including anodes prepared using a silicon comprising active material and polymeric binders of the first aspect of the invention having a degree of salt formation of 50% are able to retain a capacity of 1200 mAh/g over approximately 175 cycles.

The metal ion salt of the polymer or copolymer of the first aspect of the invention suitably comprises a linear polymer or copolymer having a number average molecular weight in the range 50,000 to 1,500,000, preferably 100, 000 to 500,000. It has been found that polymers or copolymers having a number average molecular weight in the upper part of this region have been found to exhibit superior adhesive properties and are less likely to dissolve in the electrolyte solution of an electrochemical cell. However, polymers characterised by a higher number average molecular weight tend to be less soluble in the solvents used to prepare the electrode mix. It will therefore be appreciated that the upper limit of the number average molecular weight of the metal ion salts of the polymers and copolymers of the present invention will depend, in part, on their solubility in the solvents used for the preparation of the composite electrode material. The solubility of the polymer or copolymer will also depend upon its degree of salt formation. Polymers having a degree of salt formation in the range 30 to 80%, suitably 40 to 80%, preferably 45% to 75% are generally more soluble in the solvents used to form the electrode mix compared to polymers or copolymers having a degree of salt formation of 40% or less. However, it may be desirable to use copolymers having a degree of salt formation of less than 40% where the inclusion of such binders in an electrode mix results in the formation of batteries having greater stability and/or longer cycle life. It is important that the number average molecular weight of the polymer or copolymer together with its degree of salt formation be such that the solubility of the polymer or copolymer salt in the solvents used to prepare the electrode mix is in the range 10 to 40 w/w %, preferably 15 to 40 w/w % and especially 25 to 35 w/w %. Solutions having a polymer or copolymer concentration in this range have a viscosity, which makes them suitable for the preparation of electrode mixes that can be readily applied to a substrate or a current collector. Solutions having a higher polymer concentration are too viscous and do not easily form a composite layer. Solutions having a lower polymer concentration are insufficiently cohesive to form a composite layer. Electrode mixes including the polymer or copolymer solutions of the first aspect of the invention suitably have a viscosity in the range 800 to 3000 mPa/s, preferably 1000 to 2500 mPa/s.

It has also been found that a polymer or copolymer having a solubility of 10 to 40 w/w % in solutions used to form an electrode mix tends itself to form a gel when a composite material comprising the polymer is incorporated into an electrochemical cell including an electrolyte solution. The formation of a gel is believed to promote transport of the charge carriers within the cell. Less soluble polymers or copolymers are unable to form a gel on contact with the electrolyte and are less able to facilitate the transport of charge carriers across the interface between the electrolyte solution and the electroactive material of the composite layer.

A number of suitable solvents can be used to solubilise the polymer or copolymer binder to form the electrode mix according to the first aspect of the invention. The solvent must be able to form a solution comprising at least 10 w/w % of the binder, preferably at least 15 w/w % and especially 25 to 35 w/w %. Suitable solvents include water, NMP, lower alcohols such as ethanol, propanol or butanol or mixtures of these lower alcohols with water.

The metal ion salt of the polymer or copolymer according to the first aspect of the invention suitably exhibits elastomeric properties. Preferably the polymers or copolymers of the invention exhibit a Young's Modulus of up to 5 GPa. Further the metal ion salts of the polymers or copolymers of the first aspect of the invention are preferably able to undergo an elongation of up to five times their original length before breakage. By the term “elongation to breakage” it should be understood to mean that each polymer strand can withstand being stretched up to five times its original length before it breaks or snaps. Without wishing to be constrained by theory, it is believed that the binders of the invention are able maintain the cohesive mass of the composite material even under conditions which cause them to undergo a large volume expansion. In a preferred embodiment of the first aspect of the invention there is provided a binder composition comprising a polymer or a copolymer comprising 20 to 80% of a maleic anhydride comprising monomer unit and 80 to 20% of a carboxylic acid metal ion salt comprising monomer unit selected from monomer units comprising metal ion salts of maleic acid, a maleic acid derivative, acrylic acid or an acrylic acid derivative, wherein the polymer or copolymer has a number average molecular weight in the range 100,000 to 500,000 and a degree of salt formation in the range 30 to 80%, suitably 40% to 80%, preferably 45 to 75%, more preferably 50 to 70%, especially 50 to 60% and particularly 50%, but excluding lithium salts of polyethylene-alt-maleic anhydride and lithium and sodium salts of polyethylene-co-maleic anhydride.

The binder composition of the first aspect of the invention can be characterised by its strength of adhesion to a substrate such as a current collector and/or by its solubility in a solvent used to prepare an electrode mix including the binder. The strength of adhesion is suitably measured using the peel test. The peel test involves applying a thin layer of binder to a substrate and measuring the average and peak load (or force) required to peel the adhered layer away from the substrate. The solubility of the binder can be determined by measuring the weight of the metal ion salt of the polymer or copolymer of the first aspect of the invention that can be dissolved in a fixed volume of solvent.

Composite electrode materials prepared using the binder compositions of the first aspect of the present invention are also characterised by good internal cohesion. By the term “cohesion” it should be understood to mean the tendency of the particles of the material to stick to or be attracted to each other within the mass of the material. Strongly adherent materials comprise particles that are strongly attracted to each other and tend to stick together.

Composite electrode materials prepared using the binder compositions of the first aspect of the present invention are also characterised by good adhesion to a substrate on which they are formed. By the term “adhesion” it should be understood to mean the ability of a body to stick to or be attracted to the substrate.

The binder compositions of the present invention are easily prepared and a second aspect of the invention provides a method of making a binder composition according to the first aspect of the invention. A second aspect of the invention accordingly provides a method for making a binder composition comprising a metal ion carboxylic acid salt of a polymer or a copolymer, wherein the polymer or copolymer includes as a substituent one or more carboxyl comprising groups derived from a carboxyl comprising monomer unit selected from monomers comprising an acrylic acid, an acrylic acid derivative, a maleic acid, a maleic acid derivative, a maleic anhydride and a maleic anhydride derivative, characterised in that 80 to 20% of the carboxyl groups are derived from an acrylic acid or an acrylic acid derivative, maleic acid or maleic acid derivative and 20 to 80% of the carboxyl groups are derived from a maleic anhydride or a maleic anhydride derivative but excluding lithium polyethylene-alt-maleic acid and lithium and sodium poly(acrylic acid-co-maleic acid), the method comprising mixing said polymer or copolymer with a base of a metal ion.

Alternatively, the polymer or copolymer binders of the first aspect of the invention can be prepared by polymerising a metal ion salt of a carboxylic acid monomer unit selected from the group of monomer units comprising a maleic acid salt, a maleic acid derivative salt, an acrylic acid salt and an acrylic acid derivative salt with a monomer unit comprising maleic anhydride.

In one embodiment of the second aspect of the invention, sufficient metal ions are added to a dispersion of the polymer or copolymer in a solvent to give a solution of the polymer salt in the solvent. Alternatively, in a second preferred embodiment of the second aspect of the invention, a solution of a base salt of a metal ion is added to a polymer or copolymer, which includes one or more maleic anhydride comprising units and one or more carboxyl comprising groups selected from the group comprising maleic acid, maleic acid derivative, acrylic acid or an acrylic acid derivative (such as an acrylic acid ester) to form a solution of the metal ion salt of the polymer or copolymer according to the first aspect of the invention in a solvent. In a preferred embodiment of the second aspect of the invention, a mixture of a base salt of a metal ion and a polymer or copolymer, which includes one or more ethylene maleic anhydride comprising units and one or more carboxyl groups derived from a carboxyl containing monomer unit selected from ethylene maleic acid, acrylic acid or derivatives of any of these species is further mixed with a solvent to form a solution including a metal ion salt of a polymer or copolymer according to the first aspect of the invention. In a still further embodiment of the second aspect of the invention, a solution of the base is added to a dispersion of the polymer in the solvent. Preferably the starting polymer or copolymer comprises 20 to 100% of a maleic anhydride comprising monomer unit, especially ethylene maleic anhydride and 0 to 80% of a monomer unit comprising an acrylic acid, an acrylic acid derivative, maleic acid or a maleic acid derivative, especially ethylene maleic acid.

The precise nature of the solvent used in the preparation of binders according to the first aspect of the invention is not important as long it is able to facilitate the formation of a solution comprising at least 10 w/w % and preferably at least 15 w/w % and especially 25 to 35 w/w % of the binder. The solvent must be miscible with any liquid carrier supporting a dispersion of an electroactive material with which the binder solution is mixed during formation of an electrode mix. Further, the solvent suitably supports the formation of a coating on a substrate such as a current collector. In addition the solvent is preferably sufficiently volatile to evaporate from the electrode mix, when the electrode is dried. Examples of solvents used to form the binder solution include water and lower alcohols such as ethanol, propanol and butanol and mixtures of water with one or more lower alcohols.

In a first embodiment of the second aspect of the invention, the concentration of carboxyl comprising groups within the polymer or copolymer solution or dispersion is determined using a sample of the polymer or copolymer solution as a control prior to formation of the solution or dispersion. It should be appreciated that such methods are well known to a skilled person and that by determining the concentration of carboxyl comprising groups present in the polymer or copolymer, it is possible to calculate the amount and concentration of a base comprising either mono-valent or divalent metal ions that will be required to form a polymer salt having a predetermined degree of salt formation. Preferably, the starting material is polyethylene-alt-maleic anhydride and the concentration of maleic anhydride groups within the polymer solution is determined prior to the reaction with the base. Methods of determining the concentration of carboxyl groups within a polymer structure are known to a person skilled in the art and include neutron activation techniques and spectrophotometric titration of the starting polymers or copolymers with reagents such as carbodiimides, for example.

In a further embodiment of the second aspect of the invention, the amount and concentration of the metal ions added to the polymer or copolymer dispersion is monitored in order to control the degree of salt formation of the polymer or copolymer. As mentioned previously, solutions having a polymer or copolymer concentration in the range 10 to 40% have good rheological properties and produce composite electrode materials with good cohesive and adhesive properties. As indicated previously, electrode mixes comprising 14% w/w solutions of a polymer binder are typically characterised by a viscosity in the range 800 to 3000 mPa/s, preferably 1000 to 2500 mPa/s. Electrode mixes comprising solutions having a polymer or copolymer concentration greater than 40% are too viscous and composite electrode materials formed using such solutions tend to be inhomogeneous. Composite electrode materials produced using electrode mixes comprising solutions having a polymer or copolymer concentration of below 10 w/w % are poorly cohesive and do not adhere well to the current collector. Electrode materials prepared using polymer salt solutions having a concentration in the range 25 to 35 w/w % results in a composite material that forms a gel on contact with the electrolyte solution used on battery formation. Gel formation has been found to enhance conductivity within battery cells. Preferably an electrode mix comprises a solution of a polymer or copolymer according to the first aspect of the invention having a concentration in the range 15 to 40% w/w.

It is particularly preferred to use metal ion salts of polymers or copolymers according to the first aspect of the invention in which the degree of salt formation is the minimum necessary to achieve at least 10 w/w % solubility of the polymer or copolymer salt in the solvent used for the formation of the electrode mix, preferably at least 15 w/w % and especially 25 to 35 w/w % solubility. This means that during preparation of the polymer or copolymer binders of the first aspect of the invention, only the minimum concentration of metal ions should be added to solubilise sufficient polymer or copolymer to form a solution comprising at least 10 w/w %, preferably at least 15 w/w % and especially 25 to 35 w/w % of the metal ion salt of the polymer or copolymer.

The polymer or copolymer binder salts prepared according to the second aspect of the invention can be dried and stored for later use or can be used directly for the preparation of an electrode mix that can be used to form a composite electrode material.

A third aspect of the invention provides a composite electrode material comprising an electroactive material and binder, characterised in that the binder comprises a metal ion salt of a carboxylic acid of a polymer or a copolymer, wherein the polymer or copolymer includes as a substituent one or more carboxyl comprising groups derived from a carboxyl comprising monomer unit selected from the group consisting a metal ion salt of an acrylic acid, an acrylic acid derivative, a maleic acid, a maleic acid derivative, a maleic anhydride and a maleic anhydride derivative, characterised in that 80 to 20% of the carboxyl groups are derived from a metal ion salt of an acrylic acid, an acrylic acid derivative, a maleic acid or a maleic acid derivative and 20 to 80% of the carboxyl groups are derived from maleic anhydride or a maleic anhydride derivative, but excluding lithium salts of polyethylene-alt-maleic anhydride and lithium and sodium salts of poly(acrylic acid-co-maleic acid). The electroactive materials included in the composite electrode material of the third aspect of the invention are defined above and preferably include materials that are able to form an alloy with lithium or optionally with other alkali ions such as sodium and potassium and/or with alkali earth metal ions such as calcium and magnesium. Examples of suitable electroactive materials include silicon, tin, graphite, hard carbon, gallium, germanium, aluminium, lead, zinc, tellurium, an electroactive ceramic material, a transition metal oxide, a chalconide or a structure formed from one or more of these electroactive materials, including oxides, hydrides, fluorides, carbides or metal-alloys of these materials. In a preferred embodiment of the third aspect of the invention the electroactive material is a silicon-comprising electroactive material.

The electroactive materials included in the composite material of the third aspect of the invention may be provided in the form of particles, tubes, wires, nano-wires, filaments, fibres, rods, flakes, sheets and ribbons and scaffolds.

The electroactive materials used to form the structures referred to herein above may include within their structure a dopant such as a p-type or an n-type dopant. Dopants may suitably be included in the material structure to improve the electronic conductivity of the materials. Examples of p-type dopants for silicon include B, Al, In, Mg, Zn, Cd and Hg. Examples of n-type dopants for silicon include P, As, Sb and C. The electronic conductivity of the electroactive materials may alternatively be enhanced by including in the structure chemical additives that reduce its resistivity or increase its conductivity. The electronic conductivity of a material may also be enhanced by providing a coating or inclusion of an electroactive material having a higher conductivity than the electroactive material used to form the composite on or in the structure of that material. Suitable conducting materials include metals or alloys that are compatible with cell components such as copper or carbon.

By the term “silicon-comprising electroactive material” it should be understood to mean an electroactive material, which includes silicon within its structure. The silicon-comprising electroactive material can comprise silicon having a purity of greater than 90%. The silicon comprising electroactive material suitably has a purity of less than 99.99%. Preferably the silicon-comprising electroactive material comprises silicon having a purity in the range 90 to 99.99%, preferably 90 to 99.95%, more preferably 95% to 99.95% and especially 98% to 99.95%. The silicon-comprising electroactive material can also include alloys of silicon with metals such as iron and copper, which metals do not inhibit the insertion and release of charge carriers such as lithium into the alloyed silicon during the charging and discharging phases of the battery. The silicon comprising electroactive material can also include structures having one or more silicon coatings over an electroactive or non-electroactive core or structures having a silicon core and one or more coatings applied thereto, wherein the structure of each coating layer is different to the composition of the preceding layer or the core, where the core precedes the coating layer.

Where the term “silicon-comprising electroactive material” is used herein, it should be understood to include references to electroactive materials such as tin, germanium, gallium and mixtures thereof. In this respect it should further be understood that all references to electroactive silicon particles and other silicon structures referred to herein include references to identical particles and structures formed from an electroactive material such as tin, germanium, gallium and mixtures thereof.

Examples of silicon-comprising electroactive materials that can be used in the preparation of the composite electrode material according to the third aspect of the invention include one or more silicon-comprising structures selected from the group comprising silicon-comprising particles, tubes, flakes, wires, nano-wires, filaments, fibres, rods, sheets and ribbons and scaffolds including an interconnected network of any one or more of the preceding structures.

The silicon comprising electroactive particles of the material of the first aspect of the invention may be in the form of native particles, pillared particles, porous particles, porous particle fragments, porous pillared particles or substrate particles. The silicon-comprising particles may be coated or uncoated. An electroactive material comprising silicon-comprising pillared particles or native silicon-comprising particles are preferred.

By the term “native particle” it is to be understood to include one or more particles that have not been subjected to an etching step. Such particles typically have a principle diameter in the range 10 nm to 100 μm, preferably 1 μm to 20 μm, more preferably 3 μm to 10 μm and especially 4 μm to 6 μm and are obtained by milling bulk or particulate silicon, preferably metallurgical grade silicon to the size required. By the term “metallurgical grade” silicon, it should be understood to mean a silicon material having a silicon purity in the range 90 to 99.99%, preferably 90 to 99.95, more preferably 95 to 99.95%, especially 98 to 99.95%. Typically metallurgical grade silicon includes impurities such as aluminium, copper, titanium, iron and vanadium. These impurities are generally present in parts per million (ppm) concentrations. Table 1 lists the most common impurities that are found in metallurgical grade silicon together with the concentrations in which they are present. Carbon and oxygen may also be present as impurities.

| | Impurity Level |
|---|---|
| Element | (ppm) |
| Aluminium | 1000-4350 |
| Boron | 40-60 |
| Calcium | 245-500 |
| Chromium | 50-200 |
| Copper | 15-45 |
| Iron | 1550-6500 |
| Magnesium | 10-50 |
| Manganese | 50-120 |
| Molybdenum | <20 |
| Nickel | 10-105 |
| Phosphorous | 20-50 |
| Titanium | 140-300 |
| Vanadium | 50-250 |
| Zirconium | 20 |

By the term “Pillared Particles” it is to be understood to mean particles comprising a particle core and a plurality of pillars extending there from, wherein the structures have a length in the range 0.25 to 25 μm, preferably 0.5 μm to 10 μm, more preferably 1 to 5 μm. The pillared particles comprise an electroactive material such as silicon, germanium, gallium, tin or alloys thereof. Electroactive pillared particles can be prepared by etching particles of an electroactive material such as silicon having dimensions in the range 1 to 60 μm, preferably 5 to 25 μm using the procedure set out in WO 2009/010758. Such pillared particles include particles having a principle diameter (core diameter plus pillar height) in the range 1 to 15 μm, 5 to 25 μm and 15 to 35 μm. As an example, particles having a principle diameter in the range 1 to 15 μm typically include pillars having heights in the range 0.25 to 3 μm. It is also to be understood that the term pillar when used with reference to the term “pillared particle” includes wire, nanowire, rod, filament or any other elongated structure such as a tube or cone. The pillars can also be formed on or attached to a particle core using methods such as growing, adhering or fusing.

By the term “Porous particle” it should be understood to mean particles having a network of voids or channels extending there through. The term “porous particle fragment” should be understood to include all fragments derived from silicon comprising porous particles. Such fragments include structures having a substantially irregular shape and surface morphology, these structures being derived from the silicon material originally defining or bounding the pores or network of pores within the porous particle from which the fragment structures are derived, without themselves comprising pores, channels or a network of pores or channels. These fragments will hereafter be referred to as fractals. The term silicon comprising porous particle fragment also includes porous particle fragments comprising a network of pores and/or channels defined and separated by silicon comprising walls. These fragments will herein after be referred to as pore containing fragments. Porous particles typically have a principle diameter in the range 1 to 15 μm, preferably 3 to 15 μm and contain pores having diameters in the range 1 nm to 1500 nm, preferably 3.5 to 750 nm and especially 50 nm to 500 nm. Such particles are typically fabricated using techniques such as stain etching of silicon particles or wafers or by etching particles of silicon alloy, such as an alloy of silicon with aluminium. Methods of making such porous particles are well known and are disclosed, for example, in US 2009/0186267, US 2004/0214085 and U.S. Pat. No. 7,569,202. By the term “substrate particle” it should be understood to mean a particle comprising a dispersion of an electroactive material formed on a substrate. The substrate may be an electroactive material, a non-electroactive material or a conductive material. Preferred substrate particles comprise a dispersion of nano-particles of an electroactive material having a diameter in the range 1 nm to 500 nm, preferably 1 to 50 nm, on a carbon substrate, the substrate particle having a diameter in the range 5 to 50 μm, preferably 20 μm. Alternatively the substrate particles comprise a dispersion of nano-wires of an electroactive material having a diameter in the range 10 to 500 nm and an aspect ratio in the range 10:1 to 1000:1, on a carbon substrate, the substrate particle having a diameter in the range 5 to 50 μm. Examples of substrate particles that can be used in combination with the binder of the present invention are disclosed in US 2010/0297502.

The terms “fibre, nano-wire, wire, thread, pillar and rod” should each be understood to include an elongate element which can be defined by two smaller dimensions and one larger dimension, the aspect ratio of the larger dimension to the smallest dimension being in the range 5:1 to 1000:1. In this respect the terms may be used interchangeably with each other and also with the terms pillars and threads. As specified in United Kingdom patent application number GB 1014706.4, silicon-comprising fibres preferably have a diameter in the range 0.02 to 2 μm, preferably 0.05 to 1 μm and especially 0.05 to 0.5 μm. Silicon fibres having a diameter of 0.2 μm are preferred. The composite electrode material of the third aspect of the invention may include silicon fibres, wires, nano-wires, threads, pillars or rods having a length in the range 0.1 μm to 400 μm, preferably 2 μm to 250 μm. Silicon fibres, rods, threads, pillars or wires having a length of <20 μm are preferred. The elongate structures referred to herein may be provided in the form of an individual unbranched element or may be provided in the form of a branched element. In the context of the foregoing, the term “nano-wire” should be further understood to mean an element having a diameter in the range 1 nm to 500 nm, a length in the range 0.1 μm to 200 μm and an aspect ratio of greater than 10, preferably greater than 50 and especially greater than 100. Preferably the nano-wires have a diameter in the range 20 nm to 400 nm, more preferably 20 nm to 200 nm and especially 100 nm. Examples of nano-wires that can be included in the binder compositions of the present invention are disclosed in US 2010/0297502 and US 2010/0285358.

By the term “ribbon” it should be understood to mean an element, which can be defined by three dimensions: a first dimension, which is smaller in size than the other two dimensions; a second dimension, which is larger than the first dimension; and a third dimension, which is larger than both the first and second dimensions.

By the term “flake” it should be understood to mean an element, which can also be defined by three dimensions: a first dimension, which is smaller in size than the other two dimensions; a second dimension, which is larger than the first dimension and a third dimension, which is of similar size or marginally larger than the second dimension.

By the term “tube” it should be understood to mean an element, which is also defined by three dimensions as follows: the first dimension is the tube wall thickness, which is smaller than the other two dimensions; the second dimension defines the outer diameter of the tube wall, which is larger than the first dimension; and the third dimension defines the length of the tube, which is larger than both the first and second dimensions.

By the term “scaffold” it should be understood to mean a three dimensional arrangement of one or more structured elements selected from the group comprising fibres, wires, nano-wires, threads, pillars, rods, flakes, ribbons and tubes, which structures are bonded together at their point of contact. The structured elements may be arranged randomly or non-randomly in the three dimensional arrangement. Examples of scaffold structures that can be included in the binder compositions of the present invention are disclosed in US 2010/0297502.

The electroactive structures referred to herein above may be fabricated using etching techniques such as those outlined in WO 2009/010758 or electrospinning as described in US2010/0330419. Alternatively, they can be manufactured using growth techniques such as a catalysed Vapour-Liquid-Solid approach as described in US 2010/0297502. It will be apparent to a skilled person that it is possible to grow nano-particles, nano-wires and nano-tubes on the surface of a carbon substrate to fabricate substrate particles using the technique set out in US 2010/0297502.

For each of the ribbons, tubes, threads, pillars and flakes referred to above, the first dimension is suitably of a length in the range 0.01 to 2 μm, preferably 0.03 μm to 2 μm, more preferably 0.05 μm to 1 μm, most preferably 0.1 μm to 0.5 μm. The second dimension is usually two or three times larger than the first dimension for ribbons and between 10 and 200 times larger for flakes and between 2.5 and 100 times larger for tubes. The third dimension should be 10 to 200 times as large as the first dimension for ribbons and flakes and between 10 to 500 times as large as the first dimension for tubes. The total length of the third dimension may be as large as 500 μm, for example.

Where the electroactive material present in the composite electrode material of the third aspect of the invention is a silicon-comprising electroactive material, it can suitably be selected from one or more of silicon metal, a silicon-alloy or a silicon oxide. By the term silicon metal it should be understood to include silicon having a silicon purity in the range 90% to 99.999%, preferably 90 to 99.95%, more preferably 95 to 99.95% and especially 98.0% to 99.95%. Silicon having a purity in the range 99.90 to 99.95% is preferred because higher purity silicon is more expensive to process. Silicon metal having a silicon purity of less than 90% should be avoided since the high level of impurities present in the material leads to a significant reduction in cell performance.

By the term silicon-alloy material, it should be understood to mean an alloy material comprising at least 50 wt % silicon.

By the term silicon oxide material, it should be understood to include silicon oxide materials of formula SiOx, where 0≦x<2, wherein x is either a constant value across a cross-section of the material or x varies either radially (along a radius defined by a cross-section through the silicon oxide based structure) or linearly (from one side to the other of a cross-section through the silicon oxide based structure).

It is preferred to include in the composite electrode material of the third aspect of the invention an electroactive material having a purity in the range 90.0 to 99.99%, preferably 90 to 99.95%, more preferably 95 to 99.95%, most preferably 98.0 to 99.95% and especially 99.90 to 99.95%. Preferably the electroactive material is a silicon material having a silicon purity in the range 90.0 to 99.99%, preferably 90 to 99.95%, more preferably 95 to 99.95%, most preferably 98.0 to 99.99% and especially 99.90 to 99.95%.

Porous particle fragments suitable for inclusion in the composite electrode material of the third aspect of the invention are disclosed in United Kingdom patent application GB1014706.4. Such fragments have particle diameters in the range 1 to 40 μm, preferably 1 to 20 μm and especially 3 to 10 μm. The average thickness of the walls defining the pores is of the order of 0.05 to 2 μm. The average ratio of the pore diameter to wall thickness for pore containing porous particle fragments is suitably in the range 2:1 to 25:1, preferably greater than 2.5:1.

A composite material according to the third aspect of the invention preferably comprises silicon-comprising electroactive material selected from silicon-comprising pillared particles or native silicon-comprising particles or mixtures thereof and a binder according to the first aspect of the invention. An especially preferred composite electrode material according to the third aspect of the invention comprises one or more silicon-comprising pillared particles and a sodium salt of a polyethylene-alt-maleic anhydride.

A composite electrode material according to any of the preferred embodiments of the third aspect of the invention will suitably comprise 50 to 90% of an electroactive material by weight of the electrode or anode mix or material, preferably 60 to 80% and especially 70 to 80%. The electroactive material suitably comprises from 40 to 100% of a silicon-comprising electroactive material, preferably 50 to 90% and especially 60 to 80%. Additional components may be included and suitably comprise 0 to 50% by weight of the electroactive material and 5 to 40% by weight of the composite electrode material.

In a preferred embodiment of the third aspect of the invention, the composite electrode material comprises, in addition to the silicon comprising electroactive material, an electroactive carbon material. These electroactive carbon material may be present in an amount comprising 8 to 50% of the total weight of the electroactive material, preferably 10 to 20 w/w % and especially 12 w/w %. Examples of suitable electroactive carbons include graphite, hard carbon, carbon microbeads and carbon flakes, nanotubes, graphene and nanographitic platelets or mixtures thereof. Suitable graphite materials include natural and synthetic graphite materials having a particle size in the range 3 to 30 μm. Electroactive hard carbon suitably comprises spheroidal particles having a diameter in the range 2 to 50 μm, preferably 20 to 30 μm and an aspect ratio of 1:1 to 2:1. Carbon microbeads having a diameter in the range 2 to 30 μm can be used. Suitable carbon flakes include flakes derived from either graphite or graphene.

A further preferred embodiment of the third aspect of the invention provides a composite electrode material comprising 10 to 95% by weight of a silicon-comprising electroactive material, 5 to 85% by weight of non-silicon comprising components and 0.5 to 15% by weight of a binder comprising a metal ion salt of a polymer or copolymer including within its structure a maleic anhydride monomer unit. A particularly preferred embodiment of the third aspect of the invention provides a composite electrode material comprising 70% by weight of a silicon-comprising electroactive material, 12% by weight of a binder according to the first aspect of the invention, 12% by weight graphite and 6% by weight of a conductive carbon material. Preferred metal ion salts include those derived from lithium, sodium or potassium. Composite electrode materials comprising 70 wt % of a silicon-comprising electroactive material, 14 wt % of a binder according to the first aspect of the invention, 12% of graphite and 4% of a conductive carbon material have also been found to exhibit a capacity retention of almost 100% over between 140 and 175 cycles when included in a full cell comprising a mixed metal oxide cathode and charged and discharged at 1200 mAh/g. Preferably the silicon-comprising electroactive material is a silicon structure selected from the group comprising native silicon particles, silicon-comprising pillared particles, silicon-comprising porous particles, silicon-comprising substrate particles, silicon-comprising porous particle fragments and elongate silicon-comprising elements selected from wires, nano-wires, threads, fibres, threads, rods, pillars and tubes. Silicon-comprising pillared particles and/or native silicon particles are especially preferred. Preferably the silicon comprising components have a purity in the range 90 to 99.99% or in the range 95 to 99.9%.

An especially preferred embodiment of the third aspect of the invention provides a composite electrode material comprising 70 w/w % of a silicon-comprising pillared particles and/or native silicon-comprising particles, 12 w/w % of a sodium salt of polyethylene-alt-maleic anhydride having a degree of salt formation of 75%, 12 w/w % of graphite and 6 w/w % of carbon black. Full cells including anodes comprising this composite electrode material are able to maintain a capacity of approximately 1200 mAh/g over approximately 145 cycles. A further preferred embodiment of the third aspect of the invention provides a composite electrode material comprising 70 wt % of a silicon comprising pillared particle, 14 wt % of a sodium salt of polyethylene-alt-maleic anhydride having a degree of salt formation of 50%, 12 wt % of graphite and 4 wt % of a conductive carbon. Full cells including anodes comprising this composite electrode material are able to maintain a capacity of approximately 1200 mAh/g over approximately 180 cycles.

A conductive material may also be provided in the composite electrode material to further improve the conductivity of the composite electrode material and may be added in an amount of 1 to 20% by weight based on the total weight of the composite electrode material. There is no particular limit to the type of conductive material that can be used, providing it has suitable conductivity without causing chemical changes in a battery in which it is included. Suitable examples of conductive materials include hard carbon; graphite, such as natural or artificial graphite; carbon blacks such as carbon black, acetylene black, ketjen black, channel black; conductive fibres such as carbon fibres (including carbon nanotubes) and metallic fibre; metallic powders such as carbon fluoride powder, aluminium powder, copper powder and nickel powder; conductive whiskers such as zinc oxide and potassium titanate; conductive metal oxides such as titanium oxide and polyphenylene derivatives.

The composition of the third aspect of the invention can be easily manufactured and a fourth aspect of the invention provides a method of preparing a composite electrode material according to the third aspect of the invention, the method comprising mixing an electroactive material with a binder according to the first aspect of the invention. Additional components may be used in the preparation of the composite electrode material according to the third aspect of the invention. In a first embodiment of the fourth aspect of the invention there is provided a method of preparing a composition according to the third aspect of the invention, the method comprising mixing an electroactive material with a binder according to the first aspect of the invention and optionally adding thereto a conductive material. The binder is preferably provided in the form of a solution; when it is mixed with the electroactive material and any other optional ingredients an electrode mix is formed.

In a second embodiment of the fourth aspect of the invention the binder is provided in the form of a solution, which is mixed with an electroactive material. In a third embodiment of the fourth aspect of the invention, the binder is provided in the form of a solution and the electroactive material is provided in the form of a dispersion, which dispersion is mixed with the binder solution. It is especially preferred that the solvent used in the formation of the binder solution is the same as or is miscible with the liquid carrier used to form a dispersion of the electroactive material. The solvent and the liquid carrier may be the same or different. In any event it is preferred that the solvent and the liquid carrier each have a boiling point in the range 80 to 200° C., so that they can be removed from the electrode mix via evaporation when the electrode is dried to form the composite electrode material. The composite electrode material prepared according to this fourth aspect of the invention can be used in the manufacture of electrodes, preferably anodes for use in lithium ion batteries. In a preferred embodiment of the fourth aspect of the invention, the method comprises the steps of mixing a silicon-comprising electroactive material with an aqueous solution of a binder comprising a sodium salt of polyethylene-alt-maleic acid and polyethylene-alt-maleic anhydride; the concentration of the binder in the aqueous solution is preferably in the range 10 to 20 w/w %, especially 15 w/w % and the binder preferably has a degree of salt formation of 75%.

As discussed above, the composition according to the first and third aspects of the invention can be used in the manufacture of an electrode. The electrode is typically an anode. The electrodes are preferably used in the manufacture of a lithium secondary battery or metal-air battery. A fifth aspect of the invention therefore provides an electrode comprising a current collector and a composition according to the third aspect of the invention. The composition according to the third aspect of the invention is suitably provided in the form of a composite electrode material, said material comprising an electroactive material, a binder and optionally a conductive material and other additional components referred to above. The composite electrode material can be provided in the form of a free-standing felt or mat or moulded structure for connection to a current collector. Alternatively the composite electrode material can be in the form of a layer, which is adhered to a substrate and connected to a current collector. In a particularly preferred embodiment, the substrate is a current collector and the composite electrode material is in the form of a layer applied thereto. The components of the composite electrode material from which the felt or mat is formed are preferably randomly entangled to provide optimum connectivity between the elements.

The composite electrode material is preferably porous with voids or pores extending into the structure thereof. These voids or pores provide spaces into which the liquid electrolyte can permeate; provide room into which the electroactive material can expand during the charging phase and generally increase the active surface area of the electrode. The preferred amount of porosity depends on factors such as the nature of the electroactive material, the dimensions of the electroactive material structures present in the composite and the maximum charge level of the electrode during use. Preferably the composite electrode material has a porosity of at least 15% by volume. For a silicon comprising electroactive material which undergoes a large volume expansion during charge, porosities of between 25 to 80% and especially 30 to 70% are preferred.

The electrodes of the fifth aspect of the invention are easily prepared and a sixth aspect of the invention provides a method for fabricating an electrode comprising the steps of forming an electrode mix comprising an electroactive material, a binder and a solvent; casting the electrode mix onto a substrate and drying the product to remove the solvent. The electrode mix comprises a mixture of the electroactive material, the binder and a solvent. The electrode mix typically comprises a slurry or dispersion of the electroactive material in a liquid carrier; the liquid carrier may be a solution of a binder according to the first aspect of the invention in a suitable solvent. The electrode mix is suitably prepared by dispersing the electroactive material in a solution of the binder. Alternatively, the electrode mix can be prepared by mixing a dispersion of the electroactive material in a first liquid carrier (or solvent) with a solution of a binder in a second solvent. The first or second solvents may be the same or different. Where the solvents are different they are suitably miscible. The miscible solvents typically have similar boiling points and are removed from the electrode mix by evaporation on drying. Removal of the solvent or solvents from the electrode mix results in the formation of the composite electrode material. The composite electrode material is suitably in the form of a cohesive mass which may be removed from the substrate, connected to a current collector and/or used as an electrode. Alternatively, where the composition according to the first or third aspects of the invention is adhered to the current collector as a result of casting and drying the electrode mix, the resulting cohesive mass (composite electrode material) will be connected to a current collector. In a preferred embodiment of the first aspect of the invention the composite electrode material is formed by casting the electrode mix as a layer onto a substrate, which is itself a current collector. Additional components such as a conductive material may also be included in the mix. Suitable solvents include water, alcohols such as ethanol, propanol or butanol, N-methylpyrrolidone and mixtures thereof. Other suitable solvents known to a person skilled in the art of electrode design may also be used. The amount of solvent used in the preparation of the electrode mix will depend, in part, on the nature of the electroactive material, the binder and other optional components present in the composite electrode mix. The amount of solvent is preferably sufficient to give a slurry or dispersion with a viscosity in the range 800 to 3000 mPa/s. Dispersions or slurries having a viscosity in this range give homogeneous materials having good adhesion to a substrate or current collector.

Suitable current collectors for use in electrodes according to the sixth aspect of the invention include copper foil, aluminium, carbon, conducting polymers and any other conductive materials. The current collectors typically have a thickness in the range 10 to 50 μm. Current collectors can be coated with the composite electrode material on one side or can be coated with the composite electrode material on both sides. In a preferred embodiment of the sixth aspect of the invention a composition of the third aspect of the invention is preferably applied to one or both surfaces of the current collector to a thickness of between 1 mg/cm² and 6 mg/cm² per surface such that the total thickness of the electrode (current collector and coating) is in the range 40 μm to 1 mm where only one surface of the current collector is coated or in the range 70 μm to 1 mm where both surfaces of the current collector are coated. In a preferred embodiment, the composite electrode material is applied to a thickness of between 30 and 40 μm onto one or both surfaces of a copper substrate having a thickness of between 10 and 15 μm. The current collector may be in the form of a continuous sheet or a porous matrix or it may be in the form of a patterned grid defining within the area prescribed by the grid metallised regions and non-metallised regions. In one embodiment of the sixth aspect of the invention, the electrode may be formed by casting an electrode mix including a composition according to the third aspect of the invention onto a substrate thereby to form a self supporting structure and connecting a current collector directly thereto. In a preferred embodiment of the sixth aspect of the invention, a silicon-comprising electroactive material, preferably a material comprising silicon-comprising pillared particles; a binder and optionally one or more components including a conductive material in a solvent is applied to a substrate and dried to remove the solvent. The resulting product can be removed from the substrate and used as a self supporting electrode structure. Alternatively, in a further embodiment, an electrode mix including a composition according to the third aspect of the invention is cast onto a current collector and dried to form an electrode comprising a layer of a composite electrode material applied to a current collector.

The electrode of the fifth aspect of the invention can be used as an anode in the formation of a lithium secondary battery. A seventh aspect of the invention provides a secondary battery comprising a cathode, an anode comprising an electroactive material according to the third aspect of the invention and an electrolyte.

Many of the embodiments described herein correspond to both anodes and cathodes. Although many of the references refer to anodes, it will be appreciated that cathode design is generally concerned with similar issues of ion insertion and removal, swelling, electrical conductivity, ionic mobility and others. Therefore many of the design considerations referred to herein above apply to both anodes and cathodes. The cathode is typically prepared by applying a mixture of a cathode active material, a conductive material and a binder to a cathode current collector and drying. Examples of cathode active materials that can be used together with the anode active materials of the present invention include, but are not limited to, layered compounds such as lithium cobalt oxide, lithium nickel oxide or compounds substituted with one or more transition metals such as lithium manganese oxides, lithium copper oxides and lithium vanadium oxides. Examples of suitable cathode materials include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

The electrolyte is suitably a non-aqueous electrolyte comprising a lithium salt and may include, without limitation, non-aqueous electrolytic solutions, solid electrolytes and inorganic solid electrolytes. Examples of non-aqueous electrolyte solutions that can be used include non-protic organic solvents such as N-methylpyrrolidone, propylene carbonate, ethylene carbonate, butylenes carbonate, dimethyl carbonate, diethyl carbonate, gamma butyro lactone, 1,2-dimethoxy ethane, 2-methyl tetrahydrofuran, dimethylsulphoxide, 1,3-dioxolane, formamide, dimethylformamide, acetonitrile, nitromethane, methylformate, methyl acetate, phosphoric acid trimester, trimethoxy methane, sulpholane, methyl sulpholane and 1,3-dimethyl-2-imidazolidione. The electrolyte may also be based on an ionic liquid, for example bis(fluorosulfonyl)imide or EMIF 2.4HFF.

Examples of organic solid electrolytes include polyethylene derivatives polyethyleneoxide derivatives, polypropylene oxide derivatives, phosphoric acid ester polymers, polyester sulphide, polyvinyl alcohols, polyvinylidine fluoride and polymers comprising ionic dissociation groups.

Examples of inorganic solid electrolytes include nitrides, halides and sulphides of lithium salts such as Li₅NI₂, Li₃N, LiI, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiB₁₀C₂₀, LiPF₆, LiCF₃SO₃, LiAsF₆, LiSbF₆, LiAlCl₄, CH₃SO₃L₁ and CF₃SO₃Li.

Where the electrolyte is a non-aqueous organic solution, the battery is provided with a separator interposed between the anode and the cathode. The separator is typically formed of an insulating material having high ion permeability and high mechanical strength a pore diameter between 0.01 and 100 μm and a thickness of between 5 and 300 μm. Examples of suitable electrode separators include a micro-porous polyethylene films.

The battery according to the seventh aspect of the invention can be used to drive a device, which relies on battery power for its operation. Such devices include mobile phones, laptop computers, GPS devices, motor vehicles and the like. An eighth aspect of the invention therefore includes a device including a battery according to the seventh aspect of the invention.

It will also be appreciated that the invention can also be used in the manufacture of solar cells, fuel cells, capacitors, sensors, filters and the like.

The invention will now be described with reference to the following non-limiting figures and examples. Variations on these falling within the scope of the invention will be evident to a person skilled in the art.

### FIGURES

FIG. 1 is a graph illustrating the discharge capacity versus cycle number of two full cells (in mAh/cm²), prepared according to the method set out in the examples below. Both cells contain a composite anode material comprising silicon-comprising pillared particles, a binder, graphite and conductive carbon in the weight ratio of 70:12:12:6. The electroactive material is the same in both anodes but the binder differs. One anode comprises a binder of sodium polyethylene-alt-maleic acid (formed from polyethylene-alt-maleic anhydride) having a degree of salt formation of 75%, whilst the other cell anode comprises a binder of lithium polyethylene-alt-maleic anhydride having a degree of salt formation of 75%.

FIG. 2 is a graph illustrating the discharge capacity versus cycle number of two full cells (in mAh/cm²), prepared according to the method set out in the examples below. Both cells contain a composite anode material comprising silicon-comprising pillared particles, a binder, graphite and conductive carbon in the weight ratio of 70:12:12:6. The electroactive material is the same in both anodes but the binder differs. One anode comprises a binder of sodium polyethylene-alt-maleic acid (formed from polyethylene-alt-maleic anhydride) having a degree of salt formation of 100%, whilst the other cell anode comprises a binder of lithium polyethylene-alt-maleic acid (formed from polyethylene-alt-maleic anhydride) having a degree of salt formation of 100%.

FIG. 3 is a graph illustrating the discharge capacity (mAh/cm²) versus cycle number of a full cell prepared according to the method set out in the examples below. The composite anode material comprises a mixture of silicon-comprising metallurgical grade powder particles as the active material, sodium polyethylene-alt-maleic acid (formed from polyethylene-alt-maleic anhydride) having a degree of salt formation of 75%, graphite and a conductive carbon in a ratio of 70:12:12:6. A coat weight of 18.5 g/m² was investigated.

FIG. 4 is a graph illustrating the discharge capacity (mAh/g-Si) versus cycle number of a full cell prepared according to the method set out in the examples below. The composite anode material comprises a mixture metallurgical grade silicon-comprising powder particles having an average diameter of 1 to 2 μm as the active material, sodium polyethylene-alt-maleic acid (formed from polyethylene-alt-maleic anhydride) having a degree of salt formation of 75%, graphite and a conductive carbon in a ratio of 70:10:10:10. A coat weight of 15.5 g/m² was investigated.

FIGS. 5 to 8 are graphs illustrating the discharge capacity (mAh/g-Si) versus cycle number of four sets of full cells prepared according to the method set out in the examples below. Each cell contains a composite anode material comprising a mixture of silicon pillared particles, a binder comprising a sodium salt of polyethylene-alt-maleic anhydride, graphite and a conductive carbon in a ratio 70:14:12:4. The electroactive material is the same in each cell but the binders differ from each other between sets of cells to the extent of their degree of salt formation. One anode comprises a binder of sodium polyethylene-alt-maleic anhydride having a 100% degree of salt formation (FIG. 5; cells 7a and 7b). A second anode comprises a sodium polyethylene-alt-maleic anhydride binder having a 75% degree of salt formation (FIG. 6; cells 8a and 8b). A third anode comprises a sodium polyethylene-alt-maleic anhydride binder having a 50% degree of salt formation (FIG. 7; cells 9a and 9b). Finally a fourth anode comprises a sodium polyethylene-alt-maleic anhydride binder having a 30% degree of salt formation (FIG. 8; cells 10a and 10b).

FIG. 9 is a graph illustrating the end of charge voltage vs cycle number exhibited by cells 7b, 8b, 9b and 10b respectively.

### EXAMPLES

### Preparation of Sodium Polyethylene-alt-maleic acid

For 100% Sodium Salt: 20 g (0.1587 mol) of poly(ethylene-alt-maleic anhydride) (obtained from Aldrich, Mw 100,000 to 500,000) was mixed with 25 g of deionized water. 12.6984 g (0.3175 mol) of NaOH (reagent grade, anhydrous, obtained from Aldrich) were dissolved in 75 g of deionized water. The sodium hydroxide solution was added to the polymer mix stepwise with stirring. The resulting solution gave 25 wt % of poly(ethylene-alt-maleic acid) sodium salt having a degree of salt formation of 100%.

For 75% Sodium salt: 20 g (0.1587 mol) of poly(ethylene-alt-maleic anhydride) [obtained from Aldrich], Mw 100,000 to 500,000 was mixed with 25 g of deionized water. 9.5238 g (0.2381 mol) of NaOH [reagent grade, anhydrous obtained from Aldrich] were dissolved in 75 g of deionized water. The sodium hydroxide solution was added to the polymer mix stepwise with stirring. The resulting solution gave 24 wt % of poly(ethylene-alt-maleic acid) sodium salt having a degree of salt formation of 75%.

For 50% Sodium Salt: 20 g (0.1587 mol) of poly(ethylene-alt-maleic anhydride) (Aldrich) MW 100,000-500,000 was mixed with 25 g of deionized water. 6.3492 g (0.1553 mol) of NaOH (reagent grade, anhydrous, obtained from Aldrich) were dissolved in 75 g of deionized water. The sodium hydroxide solution was added to the polymer mix stepwise with stirring. The resulting solution gave 24 wt % of poly(ethylene-alt-maleic acid) sodium salt having a degree of salt formation of 50%.

For 30% Sodium Salt: 20 g (0.1587 mol) of poly(ethylene-alt-maleic anhydride) (Aldrich) MW 100,000 to 500,000 was mixed with 25 g of deionized water. 3.8095 g (0.0932 mol) of NaOH (reagent grade, anhydrous, obtained from Aldrich) were dissolved in 75 g of deionized water. The sodium hydroxide solution was added to the polymer mix stepwise with stirring. The resulting solution gave 24 wt % of poly(ethylene-alt-maleic acid) sodium salt having a degree of salt formation of 30%.

### Preparation of Lithium Polyethylene-alt-maleic acid

For 100% Lithium Salt: 20 g (0.1587 mol) of poly(ethylene-alt-maleic anhydride) [obtained from Aldrich], Mw 100,000 to 500,000 was mixed with 25 g of deionized water. 13.3206 g (0.3175 mol) of LiOH.H2O [reagent grade, obtained from Fisher Scientific, UK] were dissolved in 75 g of deionized water. The lithium hydroxide solution was added to the polymer mix stepwise with stirring. The resulting solution gave 23.4 wt % of poly(ethylene-alt-maleic acid) lithium salt having a degree of salt formation of 100%.

For 75% Lithium salt: 20 g (0.1587 mol) of poly(ethylene-alt-maleic anhydride) [obtained from Aldrich], Mw 100,000 to 500,000 was mixed with 25 g of deionized water. 9.99 g (0.2381 mol) of LiOH.H2O [reagent grade, obtained from Fisher Scientific, UK] were dissolved in 75 g of deionized water. The lithium hydroxide solution was added to the polymer mix stepwise with stirring. The resulting solution gave 23 wt % of poly(ethylene-alt-maleic acid) lithium salt having a degree of salt formation of 75%.

### Electrode and Cell Fabrication

### Anode Preparation

The desired amount of silicon-comprising electroactive material was added to a carbon mixture that had been bead milled in deionised water. The resulting mixture was then processed using an IKA overhead stirrer at 1200 rpm for around 3 hours. To this mixture, the desired amount of binder in solvent or water was added. The overall mix was finally processed using a Thinky™ mixer for around 15 minutes. Viscosity of the mix was typically 500-3000 mPas at 20 rpm.

The silicon electroactive material was either pillared particles fabricated by etching metallurgical grade silicon powder or unetched silicon powder. The pillared particles used in the manufacture of anodes for cells 1 to 4 were made by etching and comprise a silicon core with silicon pillars and overall diameters (of core plus pillars) of 15-25 μm. Approximately 20-30% of the surface area of each particle core was covered by an array of silicon-comprising pillars of length 2-5 μm and diameter 100-400 nm. The pillared particles used for the anodes for cells 7 to 10 were made by etching and comprise a silicon core with silicon pillars and overall diameters (core plus pillars) characterised by a D₁₀ of 7 μm, a D₅₀ of 11 μm and a D₉₀ of 18 μm as measured by a Malvern MasterSizer®, a pillar diameter in the range 40 to 200 nm, a pillar length in the range 1.4 to 1.5 μm, a BET surface area of between 15 and 25 m²/g and a pillar mass fraction of 20 to 30%.

Two types of unetched silicon powder were used. One powder was of metallurgical grade silicon with particle diameters in the range 1 to 10 μm, a volume weighted mean diameter of 4.3 μm and a specific surface area of 2.7 m²/g. The second powder was of metallurgical grade silicon particles with an average particle diameter of 1-2 μm.

The metallurgical grade silicon powder used as described above was jetmilled Silgrain™ powder supplied by Elkem. The silicon purity of this material is typically in the range of 99.7-99.9 wt %, most typically around 99.8 wt %. Impurities include Al, Ca, Fe and Ti. The aluminium impurities mean that it is p-type doped.

The carbon mixture contained graphite particles and non-active conductive carbon. The amount of silicon electroactive material was 70% by weight of the total weight of the dry silicon-carbon-binder mixture. The binder formed 10-12% by weight of the dry mix and the carbon was 18-20% by weight. Table 1 below gives the precise amounts of silicon, carbon and binder used for each test cell.

The anode mixture was applied to a 10 μm thick copper foil (current collector) using a doctor-blade technique to give a 20-35 μm thick coating layer. The resulting electrode was then allowed to dry. The anode layer thickness is quoted in terms of the thickness in g/m² of the electroactive silicon component of the anode material.

### Cathode Preparation

The cathode material used in the test cells was a commercially available lithium MMO electrode material (e.g. Li₁₊ₓ,Ni_{0.8}Co_{0.15}Al_{0.05}O₂) on a stainless steel current collector.

### Electrolyte

The electrolyte used in all cells was lithium hexafluorophosphate, dissolved in a mixture of ethylene carbonate and ethyl methyl carbonate (in the ratio 3:7 by volume) and comprising 15 wt % FEC, and 3 wt % VC additives. The electrolyte was also saturated with dissolved CO₂ gas before being placed in the cell.

### Cell Construction

“Swagelok” test cells were made as follows:
Anode and cathode discs of 12 mm diameter were prepared and dried over night under vacuum.
The anode disc was placed in a 2-electrode cell fabricated from Swagelok fittings.
Two pieces of Tonen separator of diameter 12.8 mm and 16 um thick were placed over the anode disc.
40 μl of electrolyte was added to the cell.
The cathode disc was placed over the wetted separator to complete the cell
A plunger of 12 mm diameter containing a spring was then placed over the cathode and finally the cell was hermetically sealed. The spring pressure maintained an intimate interface between the electrodes and the electrolyte.
The electrolyte was allowed to soak into the electrodes for 30 minutes.

Once assembled the cells were connected to an Arbin battery cycling rig, and tested on continuous charge and discharge cycles. The constant-current: constant voltage (CC-CV) test protocol used a capacity limit and an upper voltage limit on charge, and a lower voltage limit on discharge. The voltage limits were 4.3V and 3V respectively. The testing protocol ensured that the active anode material was not charged below an anode potential of 25 mV to avoid the formation of the crystalline phase Li₁₅Si₄ alloy.

Testing Protocol: The cells were charged and discharged at a current density of 0.885 mAcm-2 corresponding to a rate of C/2. The cells were charged with limited charge capacity of 1200 mAh g_{—}1 (alloying) and the discharge capacity was measured to a cut-off voltage of 2.5V.

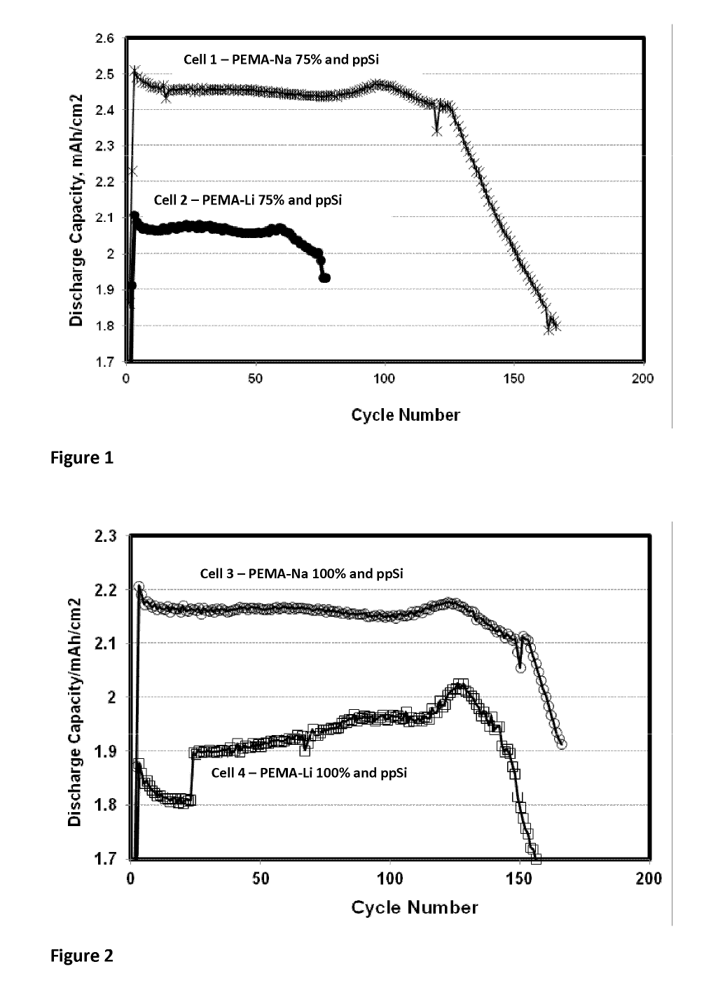

Table 2 gives some important parameters of the test cells under test. The test results are provided in FIGS. 1-4.

TABLE 2

| | | | | Anode layer |
|---|---|---|---|---|
| | Silicon anode | | | thickness |
| Cell # | material | Anode Binder | Cathode material | (g-Si/m²) |
| 1 | Pillared particles, | poly(ethylene-alt-maleic | Li₁₊ₓNi_{0.8}Co_{0.15}Al_{0.05}O₂ | 19.6 |
| | 15-25 μm | acid) sodium salt with 75% | | |
| | diameter | degree of salt formation | | |
| 2 | Pillared particles, | poly(ethylene-alt-maleic | Li₁₊ₓNi_{0.8}Co_{0.15}Al_{0.05}O₂ | 16.6 |
| | 15-25 μm | acid) lithium salt with 75% | | |
| | diameter | degree of salt formation | | |
| 3 | Pillared particles, | poly(ethylene-alt-maleic | Li₁₊ₓNi_{0.8}Co_{0.15}Al_{0.05}O₂ | 18.1 |
| | 15-25 μm | acid) sodium salt with 100% | | |
| | diameter | degree of salt formation | | |
| 4 | Pillared particles, | poly(ethylene-alt-maleic | Li₁₊ₓNi_{0.8}Co_{0.15}Al_{0.05}O₂ | 13.8 |
| | 15-25 μm | acid) lithium salt with 100% | | |
| | diameter | degree of salt formation | | |
| 5 | 4 μm metallurgical | poly(ethylene-alt-maleic | Li₁₊ₓNi_{0.8}Co_{0.15}Al_{0.05}O₂ | 18.5 |
| | grade powder | acid) sodium salt with 75% | | |
| | | degree of salt formation | | |
| 6 | 1 μm metallurgical | poly(ethylene-alt-maleic | Li₁₊ₓNi_{0.8}Co_{0.15}Al_{0.05}O₂ | 15.5 |
| | grade powder | acid) sodium salt with 75% | | |
| | | degree of salt formation | | |
| 7a | Pillared particles, | poly(ethylene-alt-maleic | Li₁₊ₓNi_{0.8}Co_{0.15}Al_{0.05}O₂ | 15.75 |
| | 15-25 μm | acid) lithium salt with 100% | | |
| | diameter | degree of salt formation | | |
| 7b | Pillared particles, | poly(ethylene-alt-maleic | Li₁₊ₓNi_{0.8}Co_{0.15}Al_{0.05}O₂ | 15.75 |
| | 15-25 μm | acid) lithium salt with 100% | | |
| | diameter | degree of salt formation | | |
| 8a | Pillared particles, | poly(ethylene-alt-maleic | Li₁₊ₓNi_{0.8}Co_{0.15}Al_{0.05}O₂ | 16.1 |
| | 15-25 μm | acid) lithium salt with 75% | | |
| | diameter | degree of salt formation | | |
| 8b | Pillared particles, | poly(ethylene-alt-maleic | Li₁₊ₓNi_{0.8}Co_{0.15}Al_{0.05}O₂ | 16.1 |
| | 15-25 μm | acid) lithium salt with 75% | | |
| | diameter | degree of salt formation | | |
| 9a | Pillared particles, | poly(ethylene-alt-maleic | Li₁₊ₓNi_{0.8}Co_{0.15}Al_{0.05}O₂ | 16.45 |
| | 15-25 μm | acid) lithium salt with 50% | | |
| | diameter | degree of salt formation | | |
| 9b | Pillared particles, | poly(ethylene-alt-maleic | Li₁₊ₓNi_{0.8}Co_{0.15}Al_{0.05}O₂ | 16.45 |
| | 15-25 μm | acid) lithium salt with 50% | | |
| | diameter | degree of salt formation | | |
| 10a | Pillared particles, | poly(ethylene-alt-maleic | Li₁₊ₓNi_{0.8}Co_{0.15}Al_{0.05}O₂ | 15.9 |
| | 15-25 μm | acid) lithium salt with 30% | | |
| | diameter | degree of salt formation | | |
| 10b | Pillared particles, | poly(ethylene-alt-maleic | Li₁₊ₓNi_{0.8}Co_{0.15}Al_{0.05}O₂ | 15.9 |
| | 15-25 μm | acid) lithium salt with 30% | | |
| | diameter | degree of salt formation | | |

Anode composition

| | | | | Conductive |
|---|---|---|---|---|
| Cell # | Silicon wt % | Binder wt % | Graphite wt % | Carbon wt % |
| 1 | 70 | 12 | 12 | 6 |
| 2 | 70 | 12 | 12 | 6 |
| 3 | 70 | 12 | 12 | 6 |
| 4 | 70 | 12 | 12 | 6 |
| 5 | 70 | 12 | 12 | 6 |
| 6 | 70 | 10 | 10 | 10 |
| 7a | 70 | 14 | 12 | 4 |
| 7b | 70 | 14 | 12 | 4 |
| 8a | 70 | 14 | 12 | 4 |
| 8b | 70 | 14 | 12 | 4 |
| 9a | 70 | 14 | 12 | 4 |
| 9b | 70 | 14 | 12 | 4 |
| 10a | 70 | 14 | 12 | 4 |
| 10b | 70 | 14 | 12 | 4 |

### Results and Discussion

It can be seen from FIGS. 1 to 9 that a composite electrode material comprising a metal ion salt of polyethylene-alt-maleic acid (formed by partial salt formation of polyethylene-alt-maleic anhydride), a structured silicon material, graphite and a conductive carbon is able to demonstrate a stable discharge capacity performance for more than 100 cycles.

FIG. 1 demonstrates that the performance of a cell comprising sodium polyethylene-alt-maleic acid (formed by partial salt formation of polyethylene-alt-maleic anhydride) having a 75% degree of salt formation (cell1) is significantly better than that of a cell comprising lithium polyethylene-alt-maleic anhydride having a 75% degree of salt formation (cell 2). Because the coating thickness of the composite material in cell 2 is less than the coating thickness of the composite material of cell 1, it would be expected that cell 2 would retain its discharge capacity over a greater number of cycles than cell 1 (the build up of stress due to expansion is generally greater for thicker coatings). The observation that the thicker coating including a sodium polyethylene-alt-maleic acid binder is able to retain a discharge capacity over a greater number of cycles than cell 2 (lithium polyethylene-alt-maleic acid binder) illustrates the superior performance of the binders of the invention compared to the prior art binders.

FIG. 2 compares that the performance of a cell comprising sodium polyethylene-alt-maleic acid having a 100% degree of salt formation (cell 3) to that of a cell comprising lithium polyethylene-alt-maleic acid having a 100% degree of salt formation (cell 4). Cell 4 has a much thinner anode layer than that of cell 3—it is around 25% thinner. Thinner anode layers usually demonstrate a much better cycle life than thicker layers, so Cell 4 should be expected to have a much better performance than Cell 3 but this is not the case in FIG. 2 and in conjunction with the results in FIG. 1, this demonstrates that the sodium polyethylene-alt-maleic acid binder (formed from polyethylene-alt-maleic anhydride) provides better performance than the lithium polyethylene-alt-maleic acid binder. Without wishing to be constrained by theory, it is believed that a degree of salt formation of less than 100%, such as 75%, is preferred because this provides free carboxylic groups within the binder molecule which are able to form an ester covalent bond with silicon thereby improving the adhesion of the binder to the silicon. The formation of this strong bond is believed to improve the mechanical strength of a silicon comprising anode layer and contribute to maintaining cohesion within the composite material during cycling where the silicon is subjected to expansion and contraction during the lithiation and delithiation process. In addition, the carboxylic acid group is believed to improve the adhesion of the silicon-comprising anode layer to the current collector (e.g. copper foil).

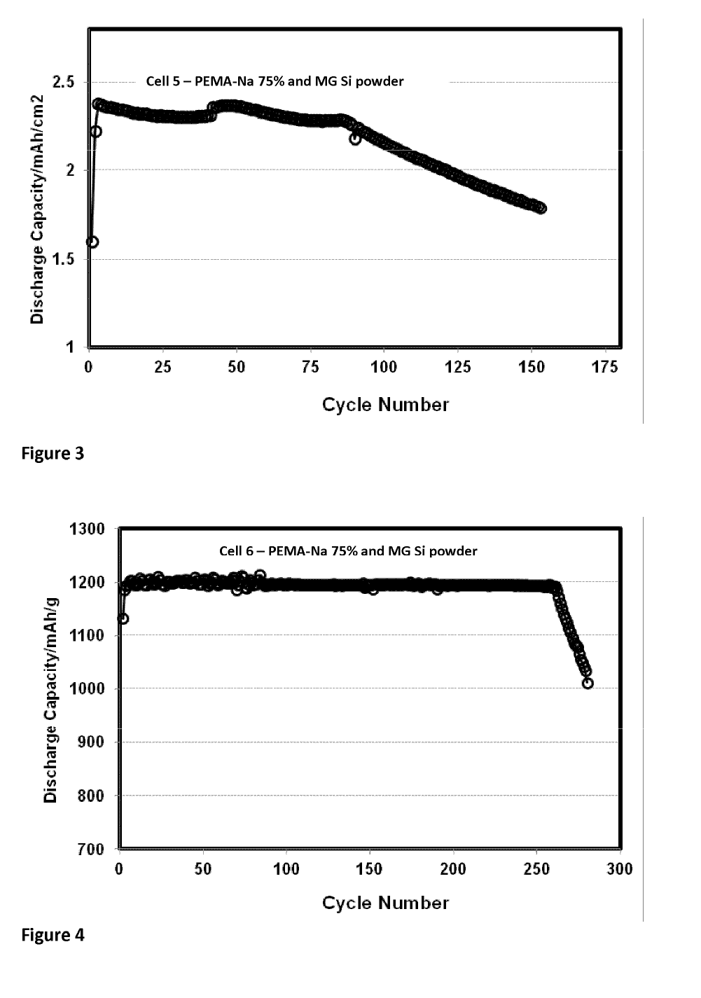

FIGS. 3 and 4 illustrate how the discharge capacity of cells comprising anodes with unetched silicon powder and a binder of sodium polyethylene-alt-maleic acid (formed from polyethylene-alt-maleic anhydride) and having a 75% degree of salt formation varies over cycle number. Composite materials comprising metallurgical grade silicon powder having particle diameter of either 4 μm or 1 μm demonstrate good performance for in excess of 100 cycles.

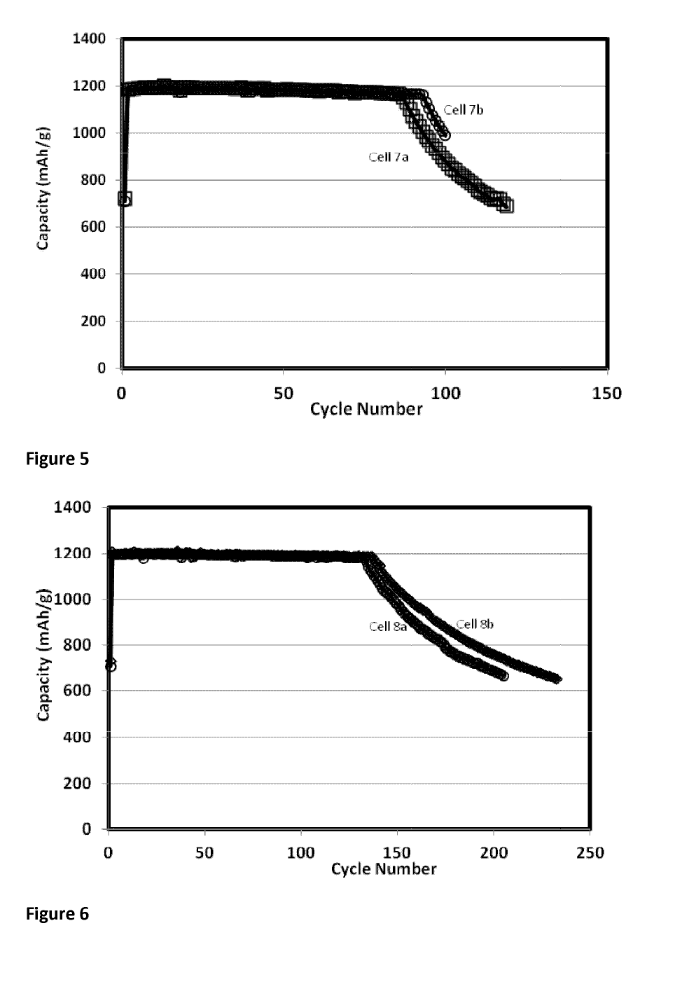

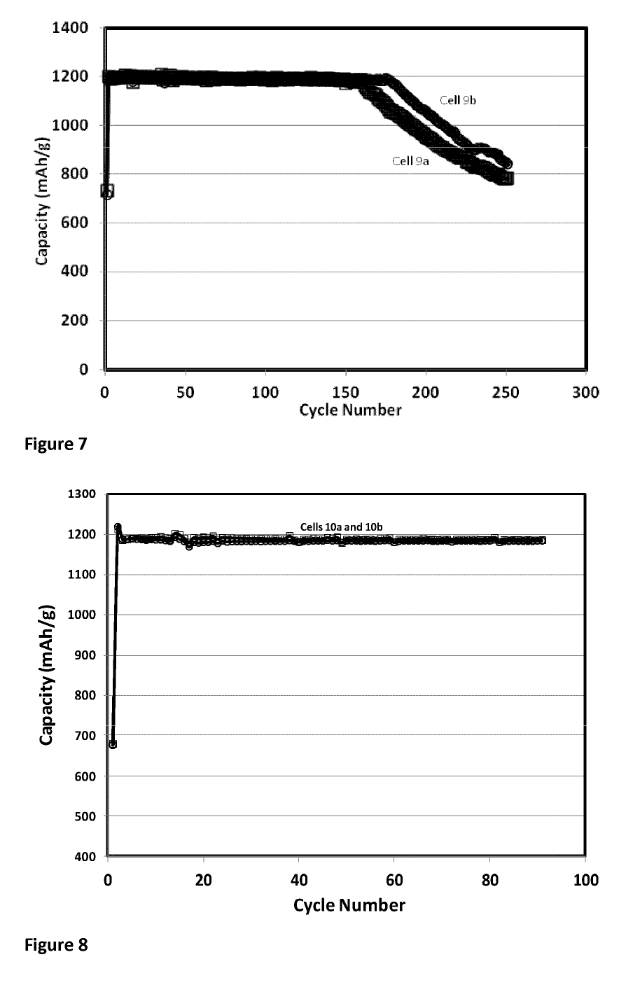

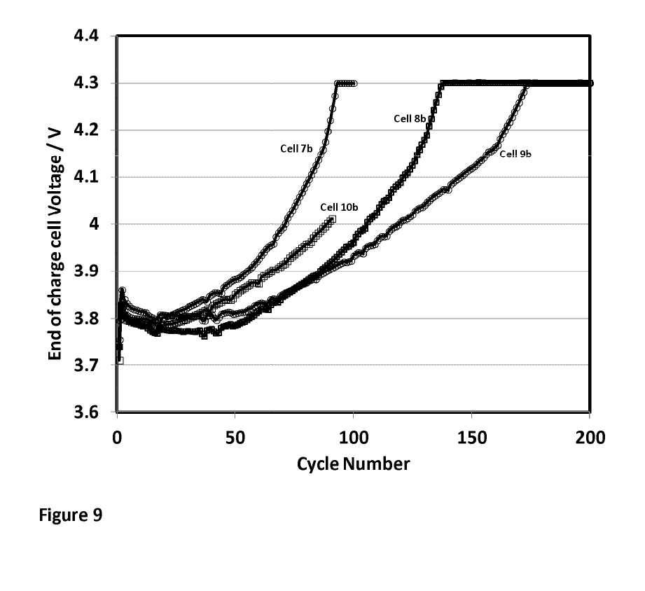

FIGS. 5 to 8 illustrate how the discharge capacity of cells comprising anodes comprising silicon pillared as the active material and binders of sodium polyethylene-alt-maleic acid (formed from polyethylene-alt-maleic anhydride) and having a degree of salt formation of 100% (FIG. 5), 75% (FIG. 6), 50% (FIGS. 7) and 30% (FIG. 8) varies over cycle number. Composite materials comprising anode materials including sodium poly(ethylene-alt-maleic acid) having a degree of salt formation of either 50% or 75% (FIGS. 7 and 6) demonstrate good performance for in excess of 100 cycles, the binder having a degree of salt formation of 50% (FIG. 7) demonstrating good performance over more than 175 cycles. FIG. 9 further illustrates that cells, which include binders that have a degree of neutralisation of the order of 50% demonstrate cycling behaviour that is superior to that of cells, which include binders that have a degree of neutralisation of 30% or 70%. The cycling behaviour of binders that were 100% neutralised was observed not to be as good as the cycling behaviour observed for binders having a degree of neutralisation of 50 or 70%.

1-38. (canceled)

39. A composite electrode material comprising an electroactive material and a binder, wherein
the electroactive material comprises one or more of silicon, tin, graphite, hard carbon, gallium, germanium, an electroactive ceramic material, a transition metal oxide, a chalconide, alloys or mixtures thereof; and
the binder comprises a metal ion salt of a polymer consisting (1) of monomer unit selected from acrylic acid or an acrylic acid derivative and (2) a monomer unit selected from maleic acid or a maleic acid derivative;
wherein
(i) the binder consists 0 to 80% of an acrylic acid or acrylic acid derivative and 20 to 100% of a maleic acid or a maleic acid derivative;
(ii) the metal ion is selected from one or both of sodium and potassium.

40. A composite electrode material according to claim 39, wherein the degree of salt formation is in the range 40 to 80%.

41. A composite electrode material according to claim 40, wherein the maleic acid monomer unit is an ethylene maleic acid unit.

42. A composite electrode materials according to claim 39, wherein the binder is able to undergo an elongation of up to five times into original length before breakage.

43. A composite electrode material according to claim 39, wherein the electroactive material is a silicon material comprising one or more of silicon-comprising particles, tubes, wires, nano-wires, fibers, rods, sheets and ribbons.

44. A composite electrode material according to claim 43, wherein the silicon comprising particles comprise one or more of native silicon-comprising substrate particles, silicon-comprising porous particles and silicon-comprising porous particle fragments.

45. A composite electrode material according to claim 39, which further includes a conductive material.

46. A composite electrode material according to claim 39, wherein the binder is a sodium salt of poly(ethylene-alt-maleic acid) and the electroactive material is selected from at least one of the silicon-comprising pillared particles and silicon-comprising native particles.

47. A method of preparing a composite electrode material according to claim 39, the method comprising the steps of foaming a binder solution and mixing the binder solution with an electroactive material, wherein
the binder solution is formed by mixing in a solvent a salt of a metal ion with a polymer consisting (i) a monomer unit selected from acrylic acid or an acrylic acid derivative and (ii) a monomer unit selected from maleic acid or a maleic acid derivative;
the electroactive material comprises one or more of silicon, tin, graphite, hard carbon, gallium, germanium, an electroactive ceramic material, a transition metal oxide, a chalconide, alloys or mixtures thereof.

48. A method according to claim 47 wherein the salt of the metal ion is selected from the group comprising hydroxides and/or carbonates of sodium and potassium.

49. A method according to claim 47 wherein the solvent is selected from one or more of water, an alcohol selected from the group comprising ethanol, propanol and butanol or mixtures thereof.

50. A method according to claim 47, wherein the electroactive material is a silicon material selected from the group comprising silicon-comprising particles, tubes, wires, nano-wires, fibers, rods, sheets and ribbons.

51. A method according to claim 47, wherein the electroactive material is a silicon-comprising electroactive material selected from the group comprising native silicon-comprising particles, silicon-comprising pillared particles, silicon-comprising substrate particles, silicon-comprising porous particles and silicon-comprising porous particle fragments.

52. A method according to claim 47, wherein one or more additional components selected from an additional electroactive material and a conductive material are formed into a slurry of dispersion with the silicon-comprising electroactive material before being mixed with the binder.

53. An electrode comprising a current collector and a composite electrode material according to claim 39.

54. A method of making an electrode according to claim 53, comprising forming a composite material onto a substrate and connecting the formed material to a current collector.

55. An electrochemical cell comprising a cathode, an anode comprising an electrode according to claim 53 and an electrolyte.

56. A device including an electrochemical cell according to claim 55.
